(19) United States
(12) Patent Application Publication
(10) Pub. No.: US 2018/0201299 A1
(43) Pub. Date: Jul. 19, 2018

(54) STEERING WHEEL CONTROLLER

(71) Applicant: X-Matik Inc., Toronto (CA)

(72) Inventor: Nima Ashtari, Toronto (CA)

(21) Appl. No.: 15/872,090

(22) Filed: Jan. 16, 2018

Related U.S. Application Data
(60) Provisional application No. 62/446,683, filed on Jan. 16, 2017.

(30) Foreign Application Priority Data
Nov. 24, 2017 (CA) 2986672

(51) Int. Cl. B62D 5/04; B62D 15/02; F16H 13/04; F16H 1/06

(52) U.S. Cl. CPC B62D 5/04; B62D 15/021; F16H 1/06; B62D 5/0433; F16H 13/04; B62D 5/0457

(57) ABSTRACT

A steering wheel controller is mountable to a steering wheel of a vehicle having a steering wheel axis and rim, the steering wheel rim having hand gripping surfaces that face away from the steering wheel axis. The steering wheel controller includes a steering wheel mount, a wheel ring, and at least one ring driver. The steering wheel mount is securable to the steering wheel without obstructing the hand gripping surfaces. The wheel ring is connected to the steering wheel mount, and defines a wheel ring axis of rotation. When the steering wheel mount is secured to the steering wheel, the wheel ring is located rearward of the steering wheel. The at least one ring driver is engageable with the wheel ring, and when engaged with the wheel ring controllable to selectively torque the wheel ring to rotate with the steering wheel mount about the wheel ring axis of rotation.

### CROSS-REFERENCE TO RELATED APPLICATIONS

This application claims priority from U.S. Provisional Application No. 62/446,683 filed on Jan. 16, 2017 and Canadian Patent Application No. 2,986,672 filed on Nov. 24, 2017, all of which are hereby incorporated by reference.

### FIELD

This disclosure relates to the field of steering wheel controllers and methods of electronically controlling the steering wheel of a vehicle.

### INTRODUCTION

Self-driving vehicles may use a series of actuation systems to control a vehicle's maneuvers, based on data gathered from environmental sensors. Such systems typically require control over the vehicle's brakes, accelerator, and steering wheel. In some vehicles, “drive by wire” technology has been designed into the vehicle from the onset which allows for both human and machine control of the steering system. These systems typically use an integrated electric/hydraulic actuator for the steering column and steering rack.

### SUMMARY

In one aspect, a steering wheel controller is provided. The steering wheel controller may be mountable to a steering wheel of a vehicle, the steering wheel having a steering wheel axis and rim, the steering wheel rim having hand gripping surfaces that face away from the steering wheel axis. The steering wheel controller may include a steering wheel mount, a wheel ring, and at least one ring driver. The steering wheel mount may be securable to the steering wheel without obstructing the hand gripping surfaces. The wheel ring may be connected to the steering wheel mount, and define a wheel ring axis of rotation. When the steering wheel mount is secured to the steering wheel, the wheel ring may be located rearward of the steering wheel. The at least one ring driver may be engageable with the wheel ring, and when engaged with the wheel ring may be controllable to selectively torque the wheel ring to rotate with the steering wheel mount about the wheel ring axis of rotation.

### DRAWINGS

FIG. 1 is a perspective view of a steering wheel controller mounted to a vehicle, in accordance with an embodiment;

FIG. 2 is a cross-sectional view taken along line 2-2 in FIG. 3;

FIG. 3 is a front elevation view of the steering wheel controller of FIG. 1 with a protective cover;

FIG. 4 is a perspective view of an exploded steering wheel mount, wheel ring, steering wheel and dashboard;

FIG. 5 is a partial front elevation view of the steering wheel controller of FIG. 1;

FIG. 6 is a front elevation view of a steering wheel controller mounted to a vehicle in accordance with another embodiment;

FIG. 7 is a cross-sectional view taken along line 7-7 in FIG. 6;

FIG. 8 is a front elevation view of the steering wheel controller of FIG. 1 with a drive gear;

FIG. 9 is a side elevation view of the steering wheel controller of FIG. 1;

FIG. 10 is a front elevation view of a steering wheel controller mounted to a vehicle in accordance with another embodiment;

FIG. 11 is a cross-sectional view taken along line 11-11 in FIG. 10;

FIG. 12 is a front elevation view of a steering wheel controller mounted to a vehicle in accordance with another embodiment;

FIG. 13 is a cross-sectional view taken along line 13-13 in FIG. 12;

FIG. 14 is a side elevation view of the steering wheel controller of FIG. 5;

FIG. 15 is a schematic of the steering wheel controller of FIG. 1;

FIG. 16 is a front elevation view of a steering wheel controller mounted to a vehicle in accordance with another embodiment;

FIG. 17 is a perspective view of the steering wheel controller of FIG. 16;

FIG. 18 is a perspective view of a steering wheel controller mounted to a vehicle in accordance with another embodiment;

FIG. 19 is a cross-sectional view taken along line 19-19 in FIG. 18;

FIG. 20 is a front elevation view of the steering wheel controller of FIG. 18;

FIG. 21 is a perspective view of a steering wheel controller in accordance with another embodiment;

FIG. 22A is a front elevation view of the steering wheel controller of FIG. 21, in a disengaged position;

FIG. 22B is a front elevation view of the steering wheel controller of FIG. 21, in an engaged position;

FIG. 23A is a cross-sectional view taken along line 23A-23A in FIG. 22A:

FIG. 23B is a cross-sectional view taken along line 23B-23B in FIG. 22B;

FIG. 24A is a front elevation view of the steering wheel controller of FIG. 21, in an engaged position and centered in the radial direction;

FIG. 24B is a front elevation view of the steering wheel controller of FIG. 21 in an engaged position and shifted radially outwardly to accommodate radial wobble;

FIG. 25A is a side view taken from the third angle projection of the side of FIG. 24A;

FIG. 25B is a side view taken from the third angle projection of the side of FIG. 24B;

FIG. 26A is a front elevation view of the steering wheel controller of FIG. 21, with an engaged drive assembly in a centered axial position;

FIG. 26B is a front elevation view of the steering wheel controller of FIG. 21, with the engaged drive assembly in a rotary tilted position, to accommodate side wobble;

FIG. 27A is a schematic illustration of a wheel ring engaged by two ring driver rotors and two ring idler rotors;

FIG. 27B is a schematic illustration of a wheel ring engaged by two ring driver rotors and one ring idler rotor;

FIG. 28 is a schematic illustration of a manual override detection method of a long-short term memory neural network;

FIG. 29 is a graphical illustration of position data of a ring driver rotor and a ring idler rotor; and

FIG. 30 is schematic illustration of the steering wheel controller of FIG. 21.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art, will recognize that the present invention, may be practiced with modification and alteration, without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment.” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs (e.g. mechanical, electronical or magnetic link). As used herein and in the claims, two or more parts are said to be “directly coupled”, “directly connected”, “directly attached”, or “directly fastened” where the parts are connected in physical contact with each other. As used herein, two or more parts are said to be “rigidly coupled”, “rigidly connected”, “rigidly attached”, or “rigidly fastened” where the parts are coupled so as to move as one while maintaining a constant location and orientation relative to each other. None of the terms “coupled”, “connected”, “attached”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical for the particular design and embodiment of the invention. Further, some steps may be performed simultaneously, and some steps may be omitted.

The present application is directed to a steering wheel controller, which can be installed on vehicles that are not equipped with “drive by wire” technology. The steering wheel controller can form part of a ‘self-driving add-on kit’ or be used to provide an alternative control methods, such as joystick or buttons, for persons with disabilities. The wheel controller is intended to be a retrofit to a manually steered vehicle to enable electric actuation of the steering wheel. The steering wheel controller, provides electric actuation of the steering wheel for accurate control of the vehicle's heading. In one aspect, the steering wheel controller may provide a method by which a steering system can be retrofitted with ‘drive-by-wire’ capability. As disclosed below, the steering wheel controller provides external control of the steering wheel while retaining the ability for the human driver to quickly regain control of the vehicle using its originally intended manual steering method at any time.

The embodiments described herein also have applications in disability vehicles, driver training, and other non-self-driving systems where electronic control of the steering wheel is required and where a self-driving system is not natively designed into the vehicle.

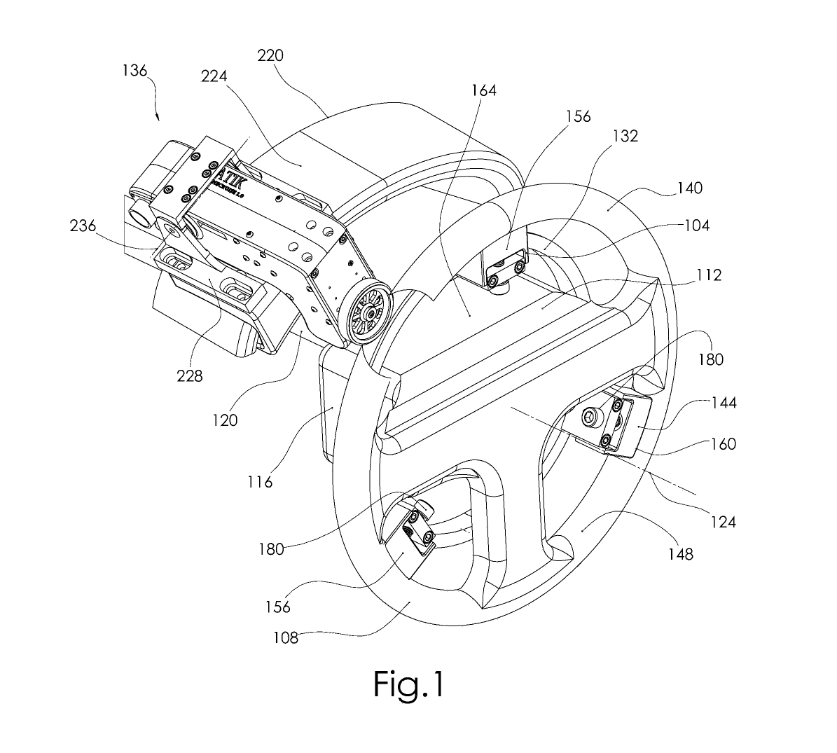

Reference is made to FIG. 1, which shows a steering wheel controller 100 retrofitted onto the steering wheel 104 of a vehicle. The vehicle can be any vehicle having a steering wheel 104, such as an automobile (e.g. car, sports utility vehicle, or truck), boat, or airplane. As shown, the steering wheel 104 includes a rim 108 rigidly connected to a hub 112. The steering wheel rim 108 at least partially surrounds the steering wheel hub 112 to provide a handgrip for a user to grasp with the user's hands. The steering wheel rim 108 can have any shape known in the art, such as the substantially circular shape shown.

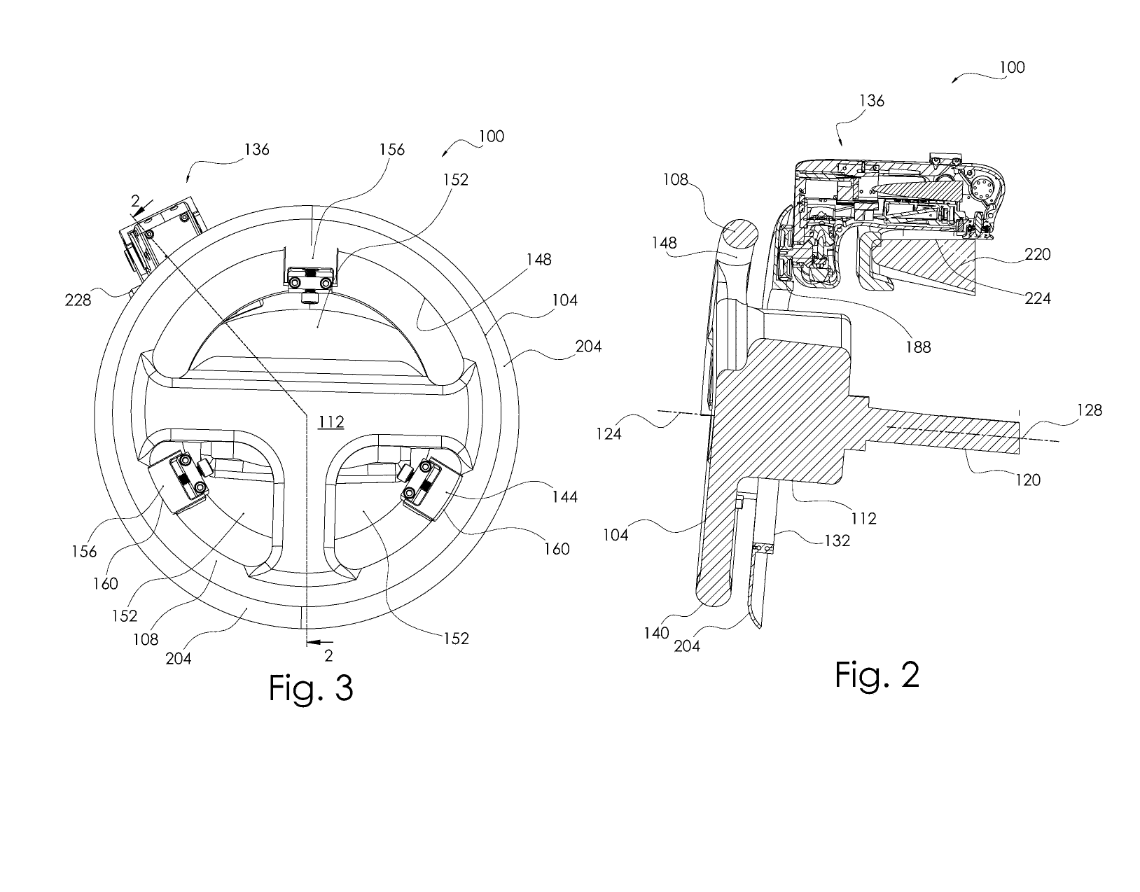

Referring to FIGS. 1-2, the steering wheel hub 112 includes a rear portion 116 that connects (e.g. rigidly connects) to a steering column 120. In some cases, the steering wheel hub 112 also includes a horn button, an air bag assembly, and user controls (e.g. multimedia controls).

The steering wheel 104 has an axis of rotation 124 that is typically collinear with the axis of rotation 128 of steering column 120. In use, a user can grip the steering wheel 104 by the steering wheel rim 108 and apply torque to rotate steering wheel 104 about the rotation axis 124, to steer the vehicle (e.g. to turn left or right).

The steering wheel controller 100 provides electronic control over the steering wheel 104 by acting upon the steering wheel 104 instead of acting upon internal components of the steering assembly such as the steering column 120. This allows the steering wheel controller 100 to be easily retrofitted to a wide variety of vehicles, including vehicles without drive-by-wire capability. As shown, the steering wheel controller 100 includes a wheel ring 132 mounted to the steering wheel 104, and a ring driver 136 drivingly coupled to the wheel ring 132. In use, the ring driver 136 torques the wheel ring 132 to rotate the wheel ring 132 and the steering wheel 104 together about the steering wheel rotation axis 124.

The wheel ring 132 can be connected to the steering wheel 104 in any manner that allows the steering wheel 104 to be rotated about the steering wheel rotation axis 124 by applying torque to the wheel ring 132. For example, the wheel ring 132 may be rigidly connected to the steering wheel 104 so that the wheel ring 132 and steering wheel 104 rotate as one.

The wheel ring 132 may be connected to the steering wheel 104 in a manner that does not obstruct or interfere with a user's grip on the steering wheel rim 108. This helps to reduce the impact of the steering wheel controller 100 on a user's control over the steering wheel 104. For example, the steering wheel rim 108 may include hand gripping surfaces 140 that face away (e.g. radially outwardly) from the steering wheel rotation axis 124, and the wheel ring 132 may be connected to the steering wheel 104 by a steering wheel mount 144 that overlies no portion of the hand gripping surfaces 140 and that holds the wheel ring 132 behind the steering wheel rim 108.

Referring to FIGS. 1 and 3, steering wheel rim 108 includes inner surfaces 148 that face towards the steering wheel rotation axis 124 (e.g. radially inwardly). For example, inner surfaces 148 may border portions of the steering wheel rim 108 that are spaced apart from the steering wheel hub 112 by an air gap 152. The steering wheel mount 144 may bear against inner surfaces 148 of the steering wheel rim 108 to secure the wheel ring 132 to the steering wheel 104. For example, the steering wheel mount 144 may include one or more steering wheel rim couplers 156. Each steering wheel rim coupler 156 may include an engagement surface 160 that faces away from the steering wheel rotation axis 128 and that engages a steering wheel rim inner surface 148. As shown, steering wheel rim couplers 156 may extend into air gaps (e.g. apertures or open areas), 152 to engage steering wheel rim inner surfaces 148.

The steering wheel mount 144 can include any number of steering wheel rim couplers 156, which can have any configuration suitable for collectively securing wheel ring 132 to the steering wheel 104. In the illustrated example, the steering wheel mount 144 is shown including three steering wheel rim couplers 156, which are spaced apart and distributed around the steering wheel rotation axis 124. In other embodiments, the steering wheel mount 144 may include just one steering wheel rim coupler 156, or a plurality of steering wheel rim couplers 156.

In some embodiments, steering wheel rim coupler(s) 156 may rigidly secure wheel ring 132 to steering wheel 104 in a manner that is removable and non-destructive (e.g. does not make any physical modification to the steering wheel 104). For example, steering wheel rim couplers 156 may be configured to apply a coupling force in an outward direction (i.e. away from steering wheel rotation axis 124) against the steering wheel 104. In some embodiments, steering wheel rim coupler(s) 156 may be connected to the steering wheel 104 by other methods, such as by adhesive, magnets, or clamps for example. Alternatively, or in addition, steering wheel rim coupler(s) 156 may be secured to the steering wheel 104 by penetrative fasteners (e.g. screws, or bolts), or welds for example.

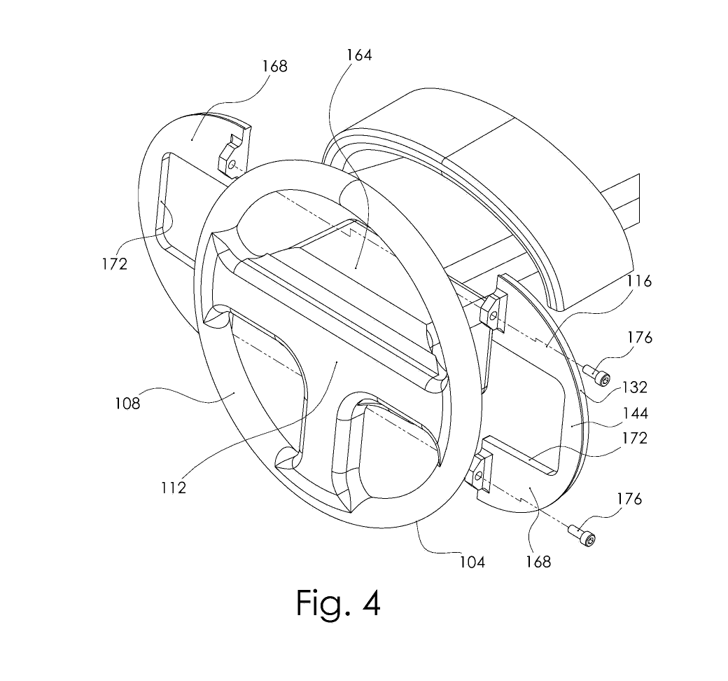

Reference is now made to FIG. 4. In some embodiments, the steering wheel mount 144 rigidly secures the wheel ring 132 to the steering wheel hub 112, instead of or in addition to securing the wheel ring 132 to steering wheel rim 108. Steering wheel mount 144 may bear against an outer surface 164 of the steering wheel hub 112 to secure the wheel ring 132 to the steering wheel 104. For example, the steering wheel mount 144 may include one or more steering wheel hub couplers 168. Each steering wheel hub coupler 168 may include an engagement surface 172 that engages steering wheel hub outer surface 164.

In some embodiments, steering wheel hub coupler(s) 168 may rigidly secure wheel ring 132 to steering wheel 104 in a manner that is removable and non-destructive (e.g. does not make any physical modification to the steering wheel 104). In the illustrated example, the steering wheel mount 144 includes two steering wheel hub couplers 168 that fasten to each other and together surround the steering wheel hub rear portion 116. As shown, the steering wheel hub couplers 168 may be connected by one or more fasteners 176 that can be tightened to clamp the steering wheel mount 144 onto the steering wheel hub 112. In some embodiments, steering wheel hub couplers 168 may be connected to the steering wheel 104 by other methods, such as by adhesive, magnets, or clamps for example. Alternatively, or in addition, steering wheel hub couplers 168 may be secured to steering wheel 104 by penetrative fasteners (e.g. screws, or bolts), or welds for example.

Referring to FIG. 1, in some embodiments, the steering wheel mount 144 is adjustable to accommodate differently sized and shaped steering wheels. For example, the steering wheel mount 144 may include steering wheel couplers 156 and/or 168 (FIG. 4) that are selectively movable inwardly and outwardly (e.g. movable radially) to make bear against the steering wheel surfaces 148 and/or 164. In the illustrated example, steering wheel rim couplers 156 are selectively radially movable to enhance the force of the steering wheel rim couplers 156 against the steering wheel rim 108. For example, steering wheel mount 144 may include adjustment screws 180 as shown, which can be manually turned to move the steering wheel rim couplers 156 radially into engagement with the steering wheel surfaces 148, ensuring a concentric arrangement between the axis of rotation 124 of the steering wheel 104 and the wheel ring 132.

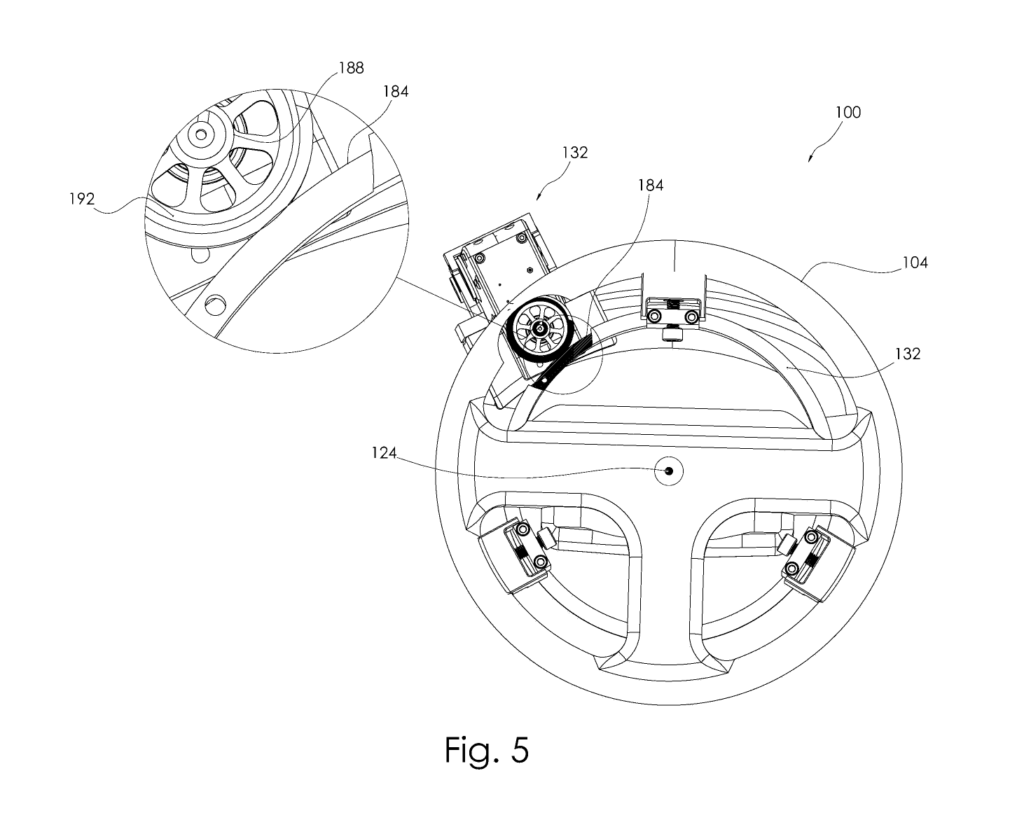

Referring to FIG. 5, the wheel ring 132 forms a closed loop around the steering wheel rotation axis 124. The ring driver 136 operates to apply a physical or magnetic force onto the wheel ring 132 to rotate it and the steering wheel 104 around the steering wheel rotation axis 124. The ring driver 136 may be stationary relative to the wheel ring 132. Preferably, the wheel ring 132 forms a circular loop centered on the steering wheel rotation axis 124 so as to simplify the coupling between the ring driver 136 and the wheel ring 132.

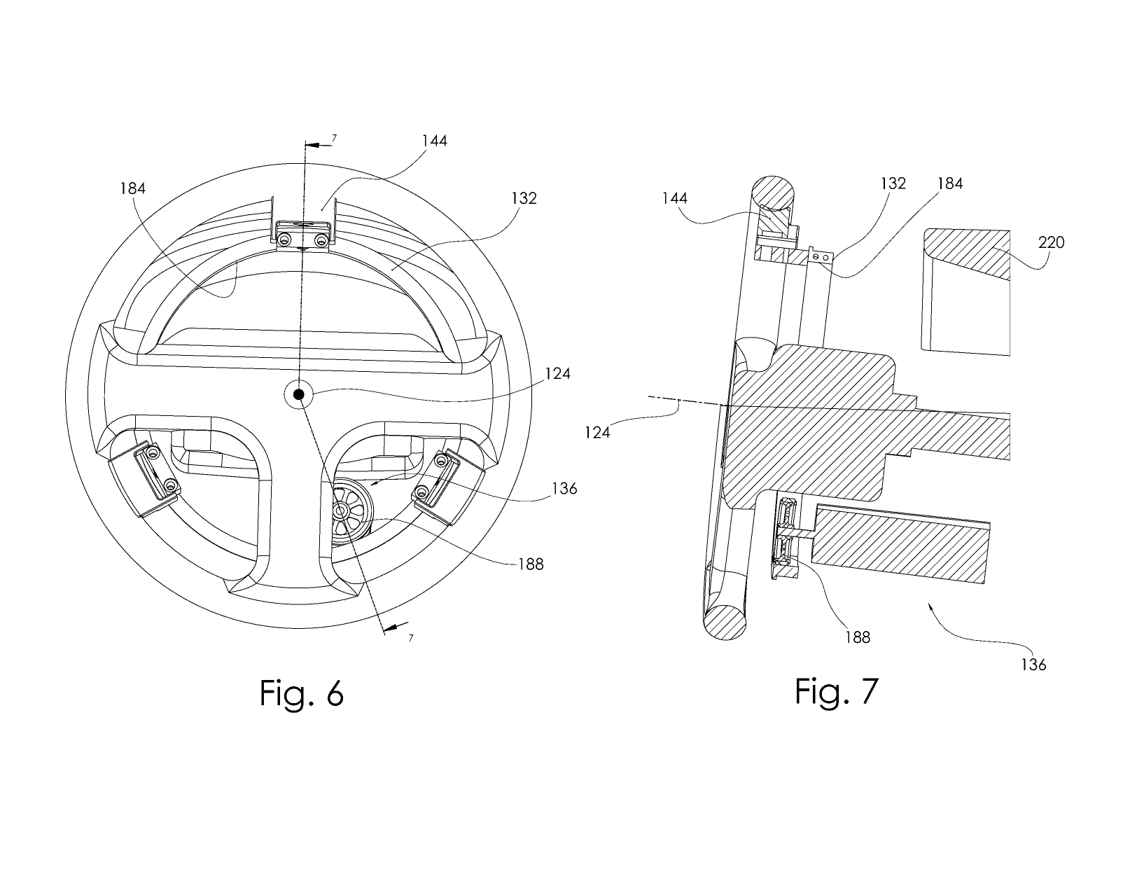

Referring to FIG. 1, the wheel ring 132 can be connected to the steering wheel mount 144 in any way that allows the wheel ring 132 to transmit torque to the steering wheel 104 by way of the steering wheel mount 144. Preferably, the wheel ring 132 is rigidly connected to the steering wheel mount 144 so that the two rotate as one. For example, the wheel ring 132 and the steering wheel mount 144 may be integrally formed, as seen in FIG. 4, or discretely formed and subsequently attached as seen in FIGS. 6-7.

Referring to FIG. 5, the ring driver 136 can be drivingly coupled to the wheel ring 132 in any manner that allows the ring driver 136 to impart a torque upon wheel ring 132 to rotate it and the steering wheel 104 together about the steering wheel rotation axis 124. For example, ring driver 136 may be configured to transmit torque to the wheel ring 132 physically (e.g. by physical contact, such as friction) or magnetically (e.g. by magnetic fields).

In the illustrated example, the wheel ring 132 includes an engagement surface 184, and the ring driver 136 includes a rotor that engages the wheel ring engagement surface 184, so the rotor 188 torques the engagement surface 184 when rotated, and thereby rotates the wheel ring 132. As shown, the engagement surface 184 forms a closed loop around the steering wheel rotation axis 124. Preferably, the engagement surface 184 is circularly shaped and centered on the steering wheel rotation axis 124.

In some embodiments, the rotor 188 frictionally engages the ring engagement surface 184. For example, the rotor 188 may include a wheel 192 that makes frictional rolling engagement with the engagement surface 184. This can allow the wheel 192 to slip in a high torque event, which can signal a user's intent to override the steering wheel controller 100 and can avoid damaging the ring driver motor. It will be appreciated that the wheel 192 may make direct physical contact with the engagement surface 184 as shown, or may make indirect frictional rolling engagement by way of an intermediate member, such as a belt or another wheel. Using an intermediary member can provide more flexibility in the mounting of the ring driver 136 inside the vehicle. The wheel 192 and engagement surface 184 may be made of any materials that providing sufficient friction to rotate the steering wheel 104, such as a low stiffness rubber for example.

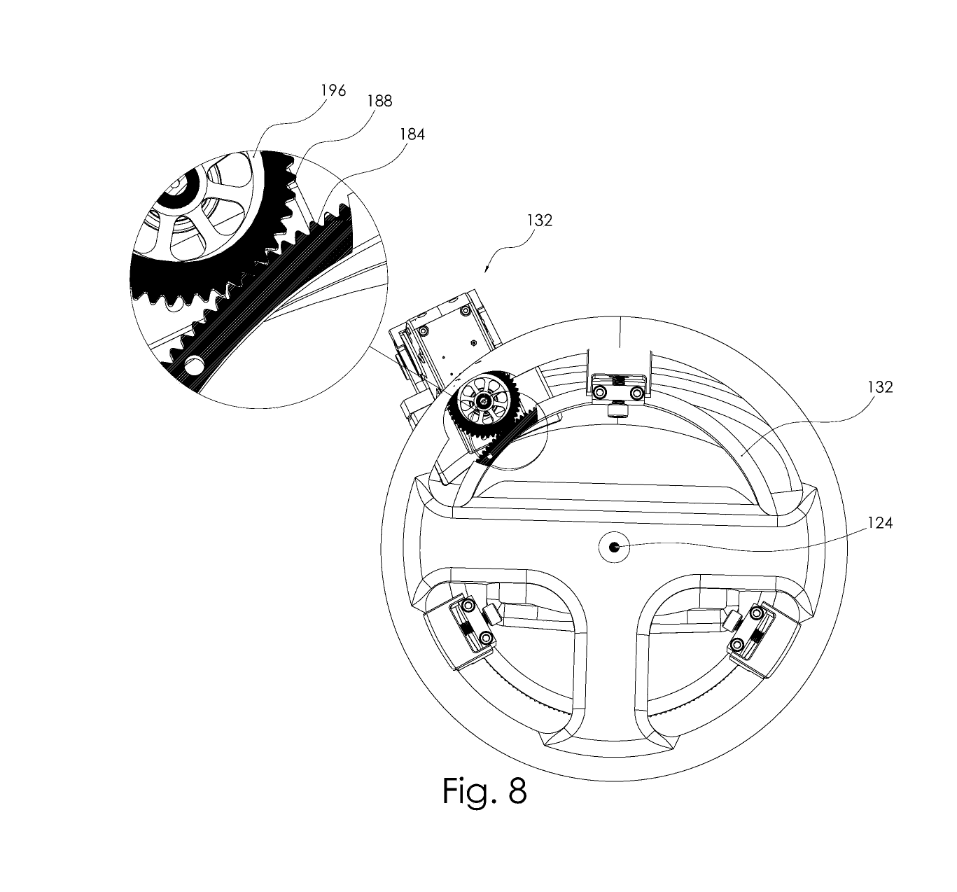

FIG. 8 shows an example in which rotor 188 includes a drive gear 196 that is meshed with a toothed engagement surface 184. Effectively, toothed engagement surface 184 forms a large gear. The drive gear 196 may be directly meshed with the toothed engagement surface 184 as shown, or indirectly by way of a chain, timing belt or another gear for example.

Engagement surface 184 may face in any direction that can allow for driving engagement with the rotor 188. In the illustrated example, the surface 184 faces outwardly away from the steering wheel rotation axis 124 (e.g. radially outwardly). In this configuration, the ring driver rotor 188 may be positioned outwardly (e.g. radially outwardly) of engagement surface 184 (and the wheel ring 132 as a whole). As a result, the wheel ring 132 may have a compact form that does not need to accommodate the ring driver rotor 188 inwardly of engagement surface 184.

FIGS. 6-7 show another example in which the surface 184 faces inwardly towards the steering wheel rotation axis 124 (e.g. radially inwardly). In this configuration, the ring driver rotor 188 may be positioned inwardly (e.g. radially inwardly) of engagement surface 184 (and wheel ring 132 as whole). As a result, the ring driver rotor 188 may be at least partially concealed and protected within the wheel ring 132. This can help reduce instances of user-contact with the rotor 188 that can lead to injury, and reduce the visual distraction of the rotor 188.

In some embodiments, the engagement surface 184 may face axially (e.g. forwardly or rearwardly, such as in parallel with the steering wheel rotation axis 124). In some embodiments, the wheel ring 132 may include a plurality of engagement surfaces 184 that face in different directions (e.g. radially inwardly and outwardly), and ring driver 136 may include a plurality of ring driver rotors 188 that collectively engage with the plurality of engagement surfaces 184.

Reference is now made to FIGS. 2-3. In some embodiments, the steering wheel controller 100 includes a protective cover 204 that overlies at least a front portion of the ring driver 136 where the ring driver 136 is drivingly coupled to the wheel ring 132. For example, the protective cover 204 may overlie at least the ring driver rotor 188. This can help prevent user-contact with the rotor 188 that can lead to injury, help block dirt and debris from accumulating on the ring driver 136, and block visibility of the rotor 188 which can be a distraction to the driver. As shown, the protective cover 204 may be connected to the wheel ring 132. For example, the protective cover 204 may be integrally formed with the wheel ring 132 as shown, or discretely formed and joined to the wheel ring 132 (e.g. by fasteners, adhesives, magnets, welds, rivets, or another means). The protective cover 204 may extend along any portion of the wheel ring 132. In the illustrated example, the protective cover 204 extends the full length of the wheel ring 132 (e.g. forming a closed loop). In alternative embodiment, the protective cover 204 may extend only along a portion the wheel ring 132, such as where the rotor 188 is positioned.

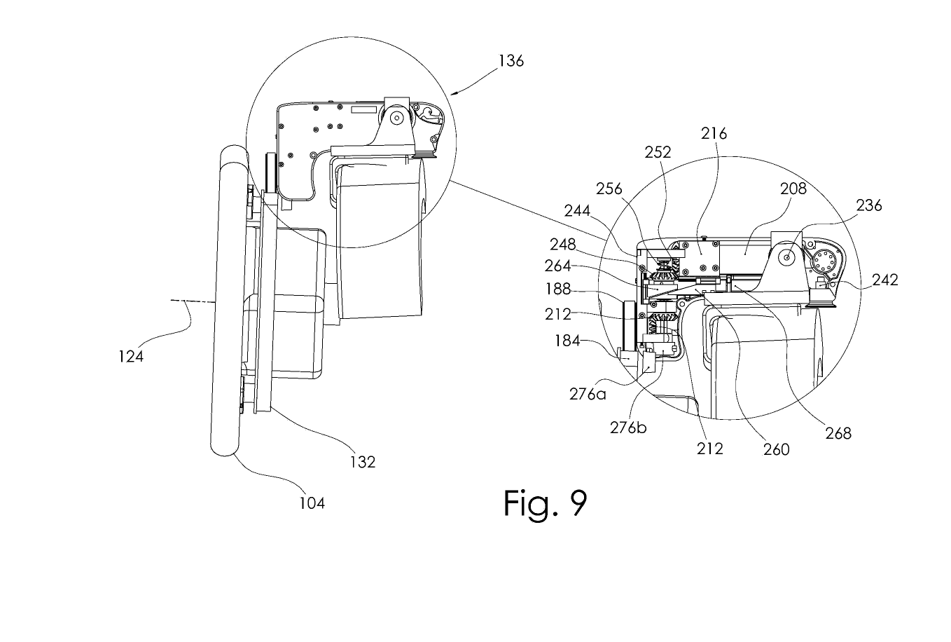

Reference is now made to FIG. 9. The ring driver rotor 188 can be driven in any manner that can provide sufficient torque and speed to rotate the steering wheel 104 to steer the vehicle in expected driving conditions (e.g. on roads and in traffic). For example, the ring driver rotor 188 may include a motor 208 which drives the rotation of the rotor 188, as shown. The ring driver motor 208 may be drivingly connected to the rotor 188 in any way, such as a direct drive configuration, or an indirect drive by way of one or more intermediaries (e.g. gears 212, chains, belts, or wheels). In one aspect, an indirect drive connection may provide greater flexibility in positioning the motor 208 to accommodate the vehicle being retrofitted with the steering wheel controller 100.

In some embodiments, the ring driver motor 208 is connected to the rotor 188 by way of transmission. The transmission may be a reducing transmission, such as reducing gearbox 216. This can allow a relatively high-speed motor 208 (which are widely available, and relatively inexpensive) to be employed, whereby the reducing gearbox 216 slows the output speed and increases the torque output to the rotor 188. Alternatively, a ring driver motor 208 that natively outputs the desired speed and torque may be used, which can avoid the use of a reducing transmission and thereby provide a more compact configuration.

The ring driver 136 can be secured in position in any manner suitable to allow the wheel ring 132 to be driven to move relative to the ring driver 136. Also, the ring driver 136 can be mounted at any location relative to the wheel ring 132. FIGS. 1-3 show an example of the ring driver 136 mounted above the wheel ring 132 and to the left of center. As shown, the steering wheel controller 100 may include a dashboard mount 228 that secures the ring driver 136 to the dashboard 220 (e.g. to dashboard upper surface 224). This may provide a convenient mounting location as the dashboard upper surface 224 may provide a relatively smooth open area for mounting the ring driver 136. However, depending on the configuration of the vehicle, this mounting configuration may partially obstruct the user's view of the instrument panel and/or view through the windshield. In other embodiments, steering wheel controller 100 may include a steering column mount that secures the ring driver 136 to the steering column 120 (FIG. 1), or another mount that secures the ring driver to another fixed surface of the vehicle.

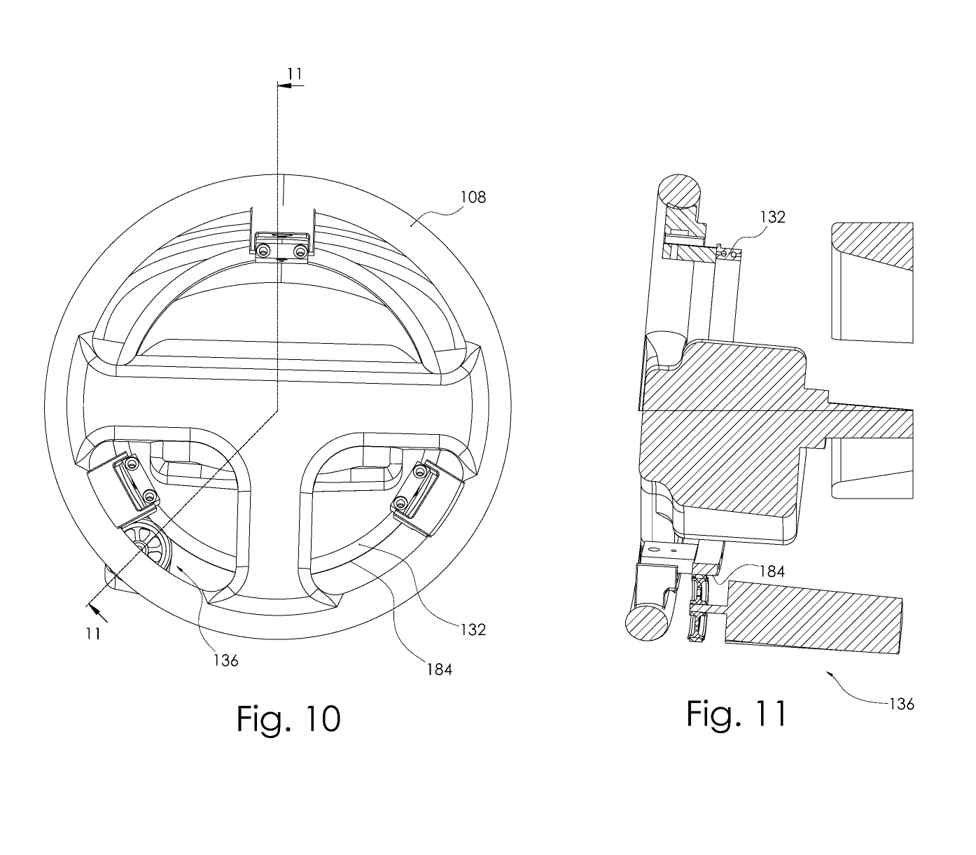

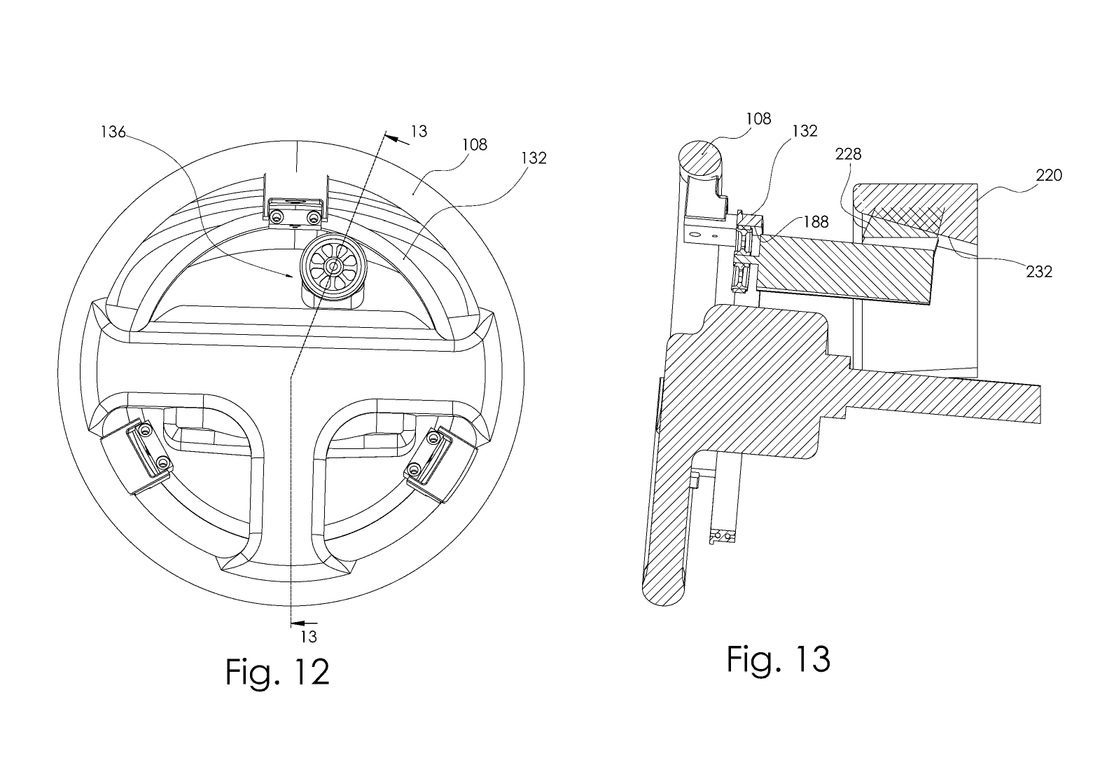

FIGS. 6-7 show an example of the ring driver 136 mounted below the wheel ring 132 and right of center. As shown, ring driver 136 may be mounted below the dashboard 220. This mounting configuration can avoid interfering with the user's visibility. However, depending on the vehicle configuration, it may interfere with the user's leg room or may not provide ideal surfaces for securely mounting the ring driver 136. FIGS. 10-11 show an example of the ring driver 136 mounted below the wheel ring 132 and to the left of center. FIGS. 12-13 show an example of the ring driver 136 mounted within (e.g. radially inwardly of) the wheel ring 132 by dashboard mount 228 to an inward facing surface 232 of the dashboard 220. This mounting configuration may reduce or eliminate any obstruction of the user's view of the instrument panel and through the windshield by the ring driver 136. In other embodiments, the ring driver 136 may be mounted to the left or right of the ring driver 136 for example.

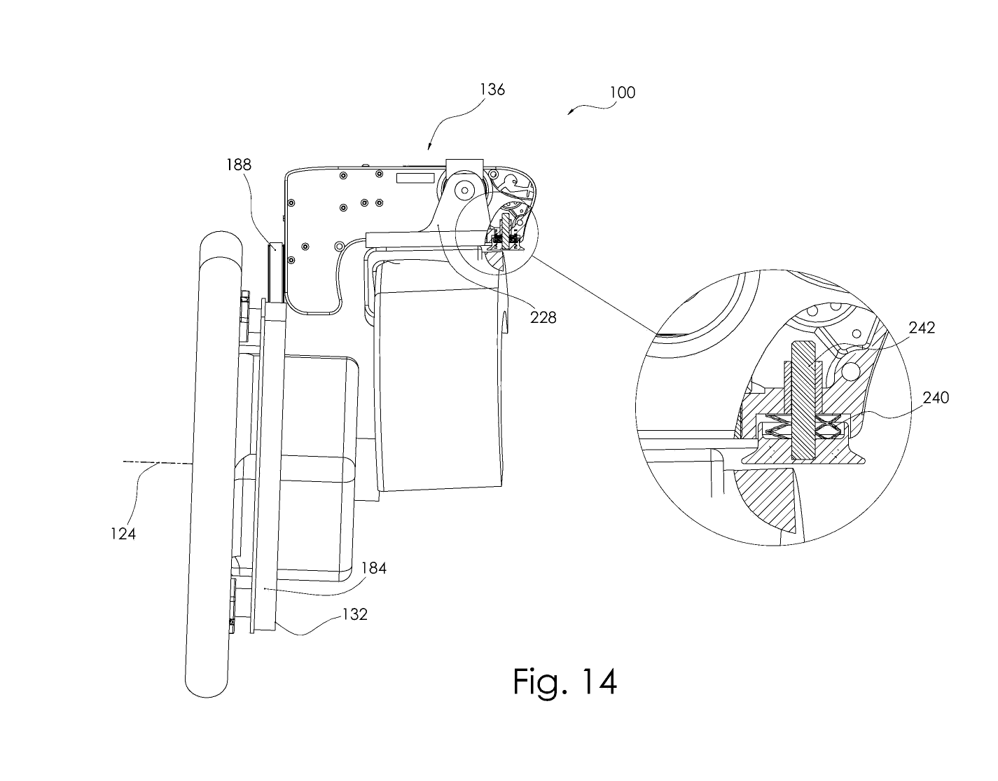

Reference is now made to FIG. 14. In some embodiments, the ring driver 136 (or a component thereof, such as ring driver rotor 188) is resiliently biased into physical engagement with the wheel ring 132 (e.g. into engagement with engagement surface 184). This increases the normal force applied to the ring driver rotor 188 to the engagement surface 184. Where the ring driver rotor 188 includes a wheel 192 (FIG. 5) in frictional rolling engagement with the engagement surface 184, a greater normal force can increase this friction and thereby reduce instances of slippage. Where the ring driver rotor 188 includes a drive gear 196 (FIG. 8), a greater normal force can help maintain engagement between the drive gear 196 and the toothed engagement surface 184. The biased engagement can also help to accommodate for any shape irregularities, which may develop from wear in the ring driver rotor 188 and the engagement surface 184, for example.

The ring driver 136 may be resiliently biased into physical engagement with the wheel ring 132 in any manner. In the illustrated example, the ring driver 136 is pivotally connected to the dashboard mount 228 about a pivot axis 236 (FIG. 1), and includes a bias 240 (e.g. a spring) that pivots the ring driver rotor 188 about pivot axis 236 (FIG. 1) towards the engagement surface 184. As shown, the pivot axis 236 may be perpendicular to and offset from the steering wheel rotation axis 124. Alternatively, or in addition, the ring driver 136 (or a component thereof, such as the ring driver rotor 188) may be linearly movable relative to wheel ring 132 and biased linearly towards the wheel ring 132. Further, as shown, bias 240 may include a passive device such as a spring. Alternatively or in addition, bias 240 may be an active device, such as a servo or solenoid 242 that can be selectively activated or deactivated.

Referring to FIG. 9, in some embodiments, the steering wheel controller 100 includes a clutch assembly 244. The clutch assembly 244 can be any device that can be selectively activated to stop the transmission of torque from the ring driver 136 to the wheel ring 132. For example, the clutch assembly 244 may be operable to mechanically disconnect a connection between the ring driver motor 208 and the ring driver rotor 188 (e.g. to separate mating gears in the transmission 216) whereby the ring driver rotor 188 is allowed to rotate independently from the wheel ring 132 and hence the steering wheel 104. Alternatively, or in addition, the clutch assembly 244 may be operable to disengage ring driver rotor 188 from engagement surface 184. For example, the clutch assembly 244 may include a selectively operable clutch actuator 242 (e.g. solenoid, or another electrical, pneumatic, or hydraulic device) to pivot ring driver 136 about the pivot axis 236 to move the ring driver rotor 188 away from the engagement surface 184, discontinuing the transmission of torque from the ring driver to the steering wheel.

Thus, the clutch assembly 244 can be activated to cease control of steering wheel controller 100 over the steering wheel 104, whereby the user may be allowed to retake control. The clutch assembly 244 may be automatically activated (e.g. by electronic control) in response to predetermined conditions. For example, clutch assembly 244 may be activated to stop torque transmission in response to sensing user-applied torque on the steering wheel 104.

Preferably, clutch assembly 244 is activated to stop torque transmission automatically in response to system power loss. This assures that the user can retake control over the vehicle in the event that the steering wheel controller 100 loses power. In the illustrated example, the transmission gear 248 is meshed with the transmission gear 252. A spring bias 256 biases the transmission gear 248 against a cam block 264. A ram 260 acts on cam block 264 and is horizontally movable to move the cam block 264 between a first position (shown) in which the transmission gear 248 is meshed with the transmission gear 252, and a second position in which the transmission gear 248 is decoupled from transmission gear 252. As shown, a ram 260 is connected to a ram actuator 268 (e.g. a solenoid, hydraulic actuator, or pneumatic actuator) that is selectively activated to move the ram 260 horizontally. Preferably, in the event of a power loss, the ram actuator 268 is deactivated, whereby the spring bias 256 is able to move transmission gear 248, cam block 264, and ram 260 from the first position to the second position in which transmission gear 248 is decoupled from transmission gear 252.

The steering wheel controller 100 may include one or more sensor 276. The sensors 276 can be any type of sensor known in the art that can sense the movement and/or position of the ring driver rotor 188 and the wheel ring 132. For example, sensors 276 may be optical encoders, haul effect sensors, electromagnetic sensors, magnetic sensors, ultrasonic sensors, or combinations thereof. In the illustrated embodiment, the steering wheel controller 100 includes a wheel ring sensor 276a that senses the movement and/or position (e.g. rotational movement/position around steering wheel rotation axis 124) of the wheel ring 132, and a ring driver sensor 276b that senses the movement and/or position of the ring driver rotor 188.

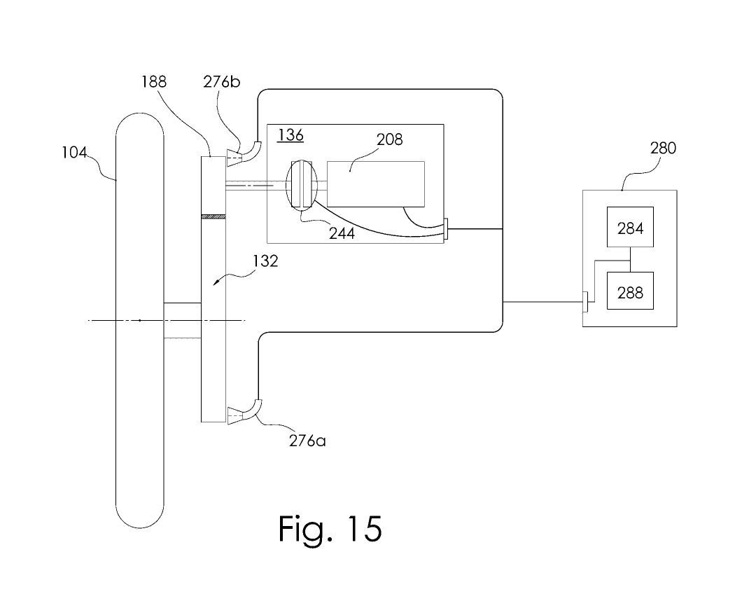

As shown in FIG. 15, the steering wheel controller 100 may include a computing device 280 (e.g. having a processor 284 and memory 288) that is communicatively coupled (e.g. by wire or wirelessly) to sensors 276 and the ring driver 136 that together, provide a feedback loop. For example, computing device 280 may direct (e.g. send control signals to) the ring driver 136 to torque the wheel ring 132, receive sensor information from sensors 276 on the position and/or movement of the wheel ring 132 and the ring driver rotor 188, and then based on the sensor information issue further directions to the ring driver 136.

In some embodiments, the computing device 280 may determine whether there are any inconsistencies between the sensed movement/position of the wheel ring 132, and the movement/position of the ring driver rotor 188. For example, each rotation of ring the driver rotor 188 may correspond to a specific angular rotation of the wheel ring 132, and slippage between the ring driver rotor 188 can be inferred where that relationship is not reflected in the sensor readings. The nature of the slippage may indicate that the user is attempting to retake control over the steering wheel 104. In this case, the computing device 280 may direct (e.g. send control signals to) clutch assembly 244 to stop torque transmission and allow the user to have control over the steering wheel 104. Alternatively, the nature of the slippage may indicate unintentional slippage, free of any user intervention to retake control over the steering wheel 104. In this case, computing device 280 may compensate for the slippage by sending additional directions to the ring driver 136 (e.g. by applying additional torque).

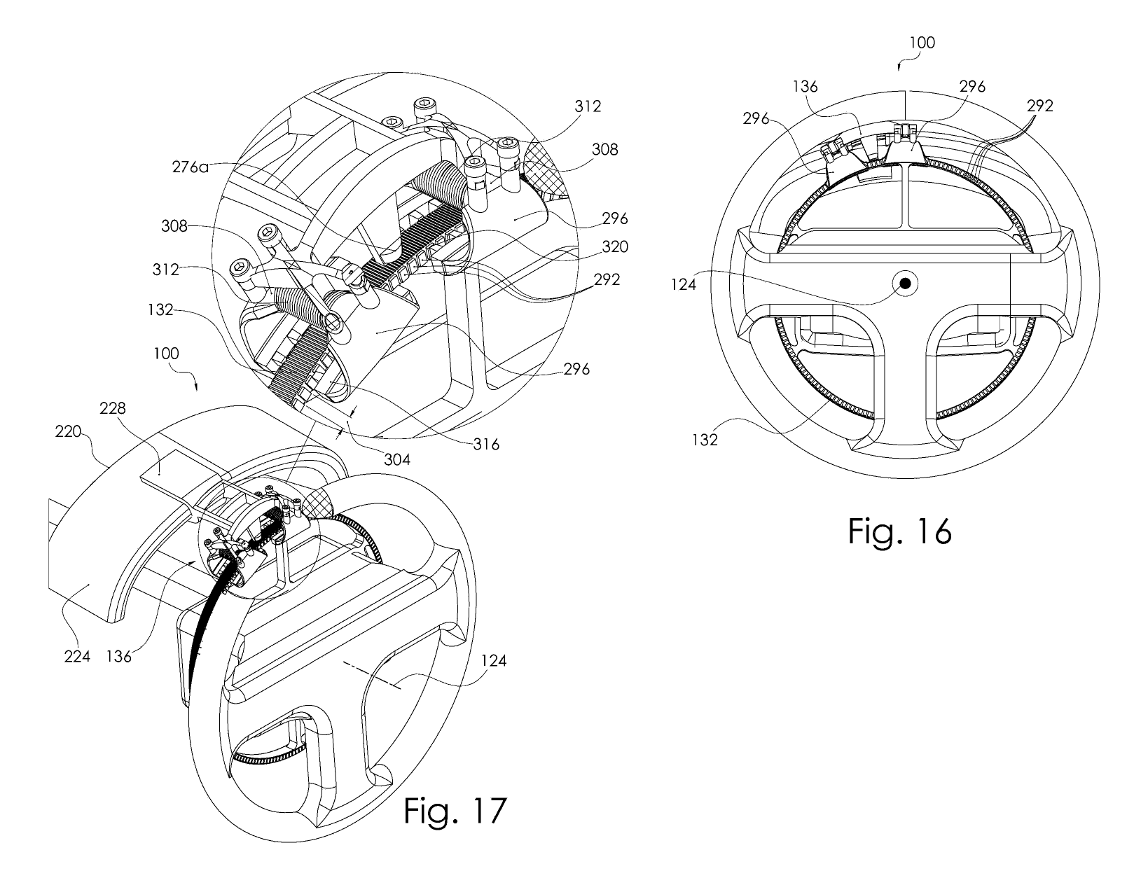

Reference is now made to FIG. 16, which shows a steering wheel controller 100 in accordance with another embodiment in which the ring driver 136 magnetically transmits torque to the wheel ring 132. The ring driver 136 can magnetically transmit torque to the wheel ring 132 in any manner. In the illustrated embodiment, the wheel ring 132 includes an array of rotor magnets 292 distributed along the wheel ring 132 around the steering wheel rotation axis 124, and the ring driver 136 has at least two stator magnets 296. As shown, the rotor magnets 292 may be permanent magnets, and the stator magnets 296 may be electromagnets selectively able to be energized in order to magnetically torque wheel ring 132 to rotate.

Turning to FIG. 17, the rotor magnets 292 may be identical and evenly distributed in a closed loop around the wheel ring 132 according to a rotor magnet pitch 304 (center-to-center distance between adjacent rotor magnets 292). Together, rotor and stator magnets 292 and 296 may form a stepper motor, where the rotor magnet pitch 304 defines the step size, which affect positioning tolerance of the wheel ring 132. A smaller rotor magnet pitch 304 (or greater number of rotor magnets 292) may allow for greater positional accuracy as the ring driver 136 magnetically torques the wheel ring 132 to rotate. In some embodiments, the wheel ring 132 includes at least 180 rotor magnets 292 to provide a positional accuracy of 2 degrees or better (i.e. 2 degrees or less).

It will be appreciated that a ring driver 136, which transmits torque magnetically, may not include a clutch assembly, which moves components to mechanically disconnect the transfer of torque from the ring driver 136 to the wheel ring 132. Instead, the torque transmission can be stopped by cutting power to the ring driver 136, which deactivates stator electromagnets 296 and thereby ceases the magnetic field that was acting on the rotor magnets 292, freeing the wheel ring and hence the steering wheel to rotate freely by the operator's hands.

Still referring to FIG. 17, stator magnets 296 can have any configuration suitable for generating a magnetic field that can drive rotor magnets 292 to rotate with the wheel ring 132 about steering wheel rotation axis 124. In the illustrated embodiment, stator magnets 296 are substantially C-shaped, each having a central portion 308 wound with wire 312 and two opposed end portions 316 which define the north and south poles. As shown, stator magnets 296 are positioned and oriented with the opposed end portions 316 flanking the opposed north and south poles of the rotor magnets 292. The stator electromagnet coil 312 is wound with a center axis aligned with the rotor magnet poles in the end portion 316.

In the illustrated example, the rotor and stator magnets 292 and 296 are oriented with their poles aligned axially (e.g. in parallel with the steering wheel rotation axis 124). In this configuration, the axial forces are substantially cancelled by the flanking configuration of the stator magnets 296. The air gap 320 between the stator magnet end portions 316 and the rotor magnets 292 is preferably small, such as less than 5 mm.

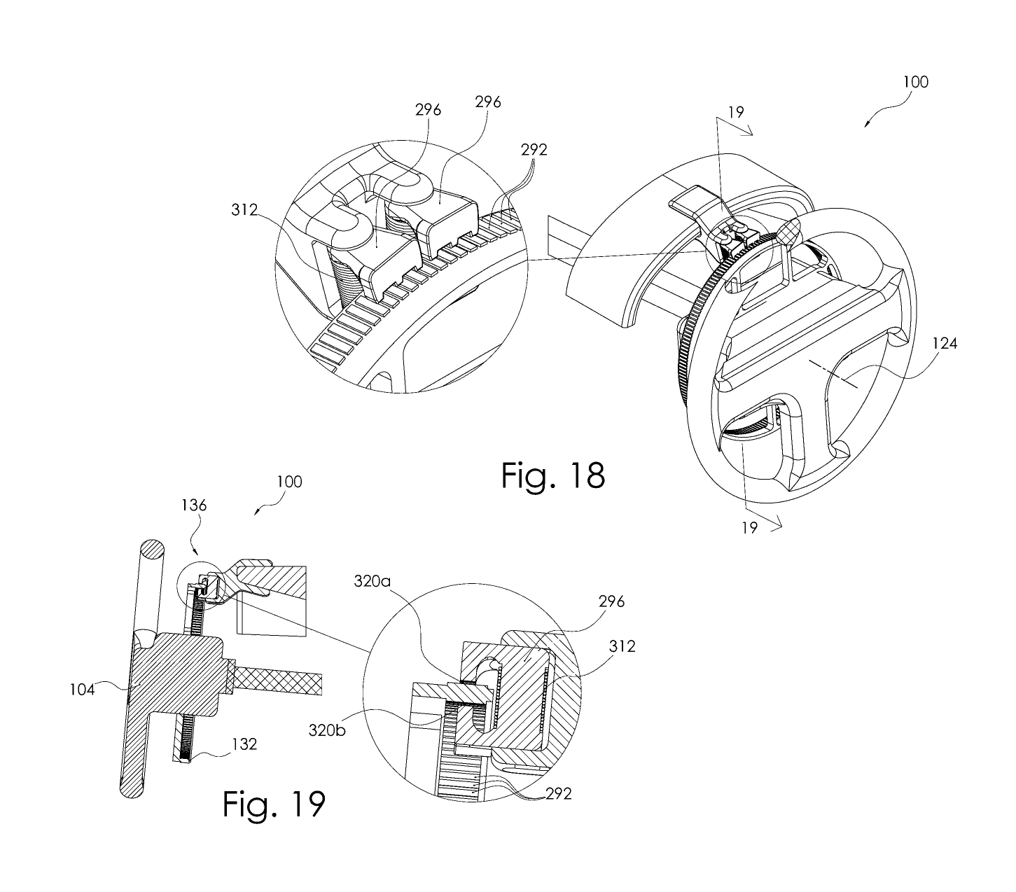

FIG. 18 shows another embodiment in which the rotor and stator magnets 292 and 296 are oriented with their poles aligned radially (e.g. perpendicular to steering wheel rotation axis 124). This orientation can allow up to twice as much torque to be developed, all else being equal. However, the radial orientation may also lead to misbalanced loads towards/away from the steering wheel rotation axis 124. Referring to FIG. 19, this misbalance in radial force may be reduced by providing a radially outer air gap 320a that is lesser than the radially inner air gap 320b.

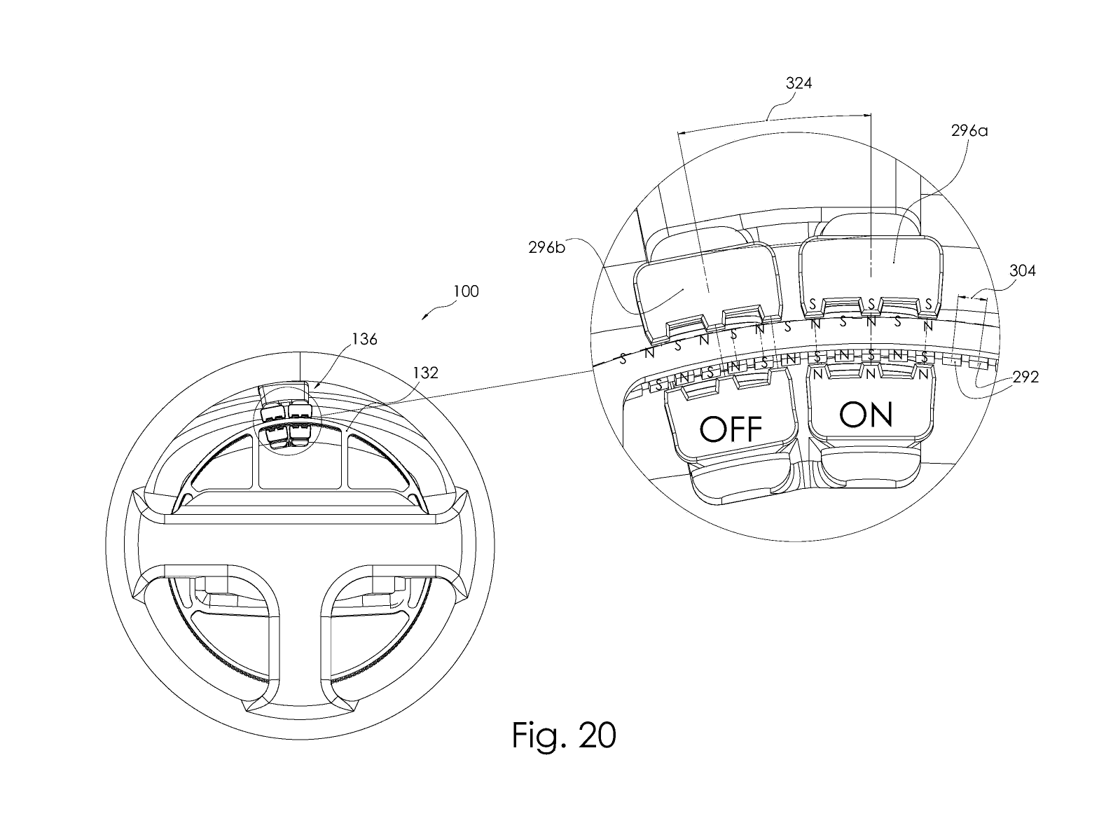

Turning to FIG. 20, the ring driver 136 can include two or more stator magnets 296. In the illustrated embodiment, the ring driver 136 includes two stator magnets 296. Alternatively, the ring driver 136 may include three, four, or more stator magnets 296. As shown, stator magnets 296 are spaced apart according to a stator magnet pitch 324 (center-to-center spacing). Stator magnets 296 should be positioned out of phase with rotor magnets 292. In other words, the stator magnet pitch 324 should not be a whole number multiple of the rotor magnet pitch 304. This can allow stator magnets 296 to be activated in alternating fashion to generate magnetic fields that propel the wheel ring 132 to rotate. Reversing the polarity of current through stator magnet windings 312 (FIG. 17) reverses the direction of rotation. In the illustrated embodiment, the stator magnets 296 are out of phase with the rotor magnets 292 by one half the rotor magnet pitch 304, such that when one stator magnet 296a has poles aligned exactly with the poles of the rotor magnets 292, the other stator magnet 296b has poles aligned exactly half way between the poles of the rotor magnets 292.

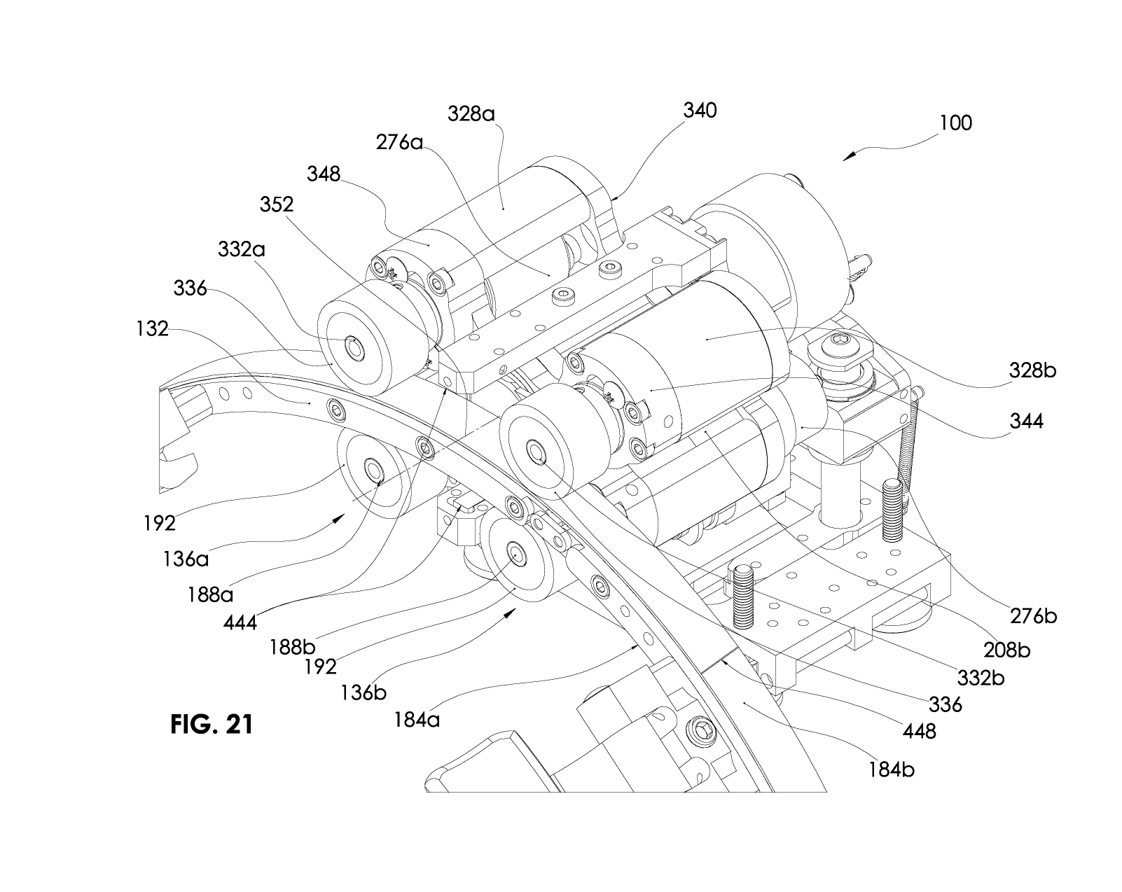

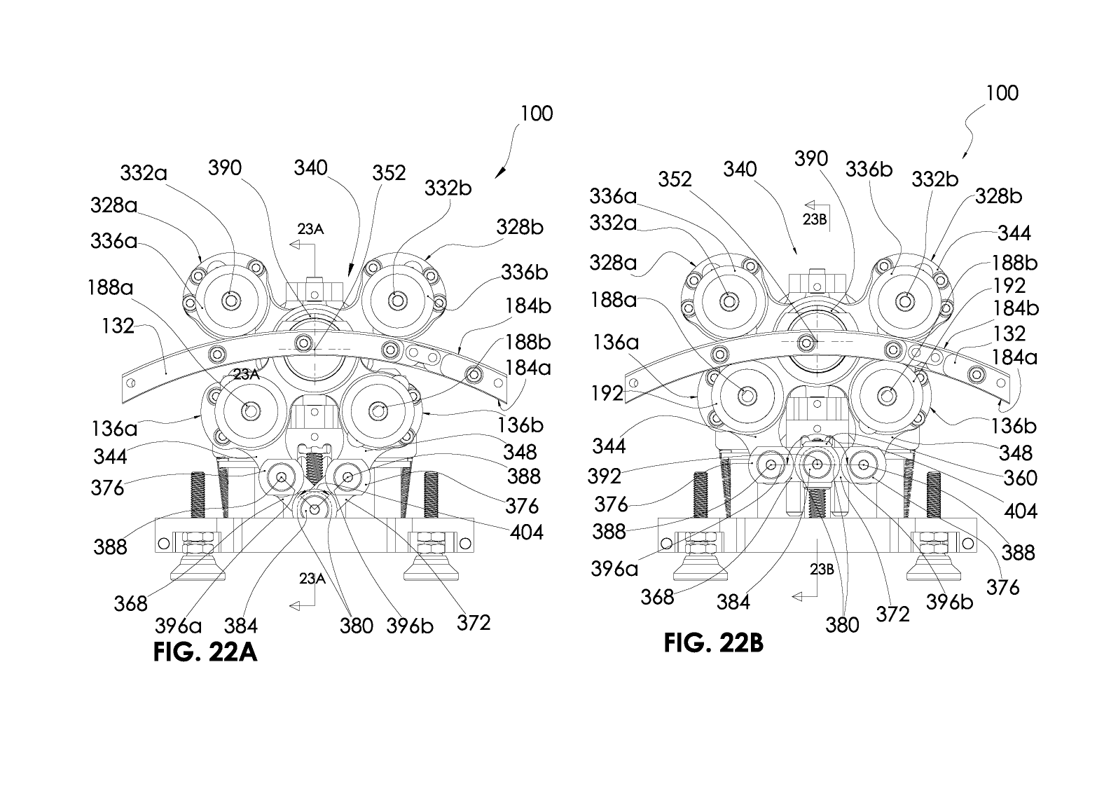

Reference is now made to FIG. 21, which illustrates a steering wheel controller 100 in accordance with another embodiment. As shown, steering wheel controller 100 may include one or a plurality of ring drivers 136, and one or a plurality of ring idlers 328. Collectively, the ring driver(s) 136 and ring idler(s) 328 may be movable between a disengaged position (FIG. 22A) in which at least ring driver(s) 136 is disengaged from wheel ring 132, and an engaged position (FIG. 22B) in which driver(s) 136 and ring idler(s) 328 clamp onto wheel ring 132. In the engaged position (FIG. 22B), ring driver(s) 136 is urged into firm contact with wheel ring 132 to mitigate slippage as ring driver(s) 136 is energized to apply torque to drive wheel ring 132. In the disengaged position (FIG. 22A), ring driver(s) 136 is disengaged (e.g. spaced apart) from wheel ring 132 to permit manual user operation of the steering wheel attached to wheel ring 132. In some embodiments, ring idler(s) 328 may remain engaged with wheel ring 132 when ring driver(s) 136 is disengaged, and may be equipped with a sensor to continue tracking the position of the steering wheel and wheel ring 132.

Still referring to FIG. 21, the illustrated example shows a steering wheel controller 100 including two circumferentially spaced apart ring drivers 136, and two circumferentially spaced apart ring idlers 328. The use of a plurality of ring drivers 136 as shown may permit better detection of slippage and provide greater torque as compared with a single ring driver 136, all else being equal.

Referring to FIG. 22B, in the engaged position, the ring drivers 136 and ring idlers 328 may contact opposite sides of wheel ring 132. This allows ring drivers 136 and ring idlers 328 to apply compressive clamping forces onto wheel ring 132 when in the engaged position, which may mitigate slippage. The illustrated example shows an engaged position in which ring drivers 136 engage an inner surface 184a of wheel ring 132 and ring idlers 328 engage an outer surface 184b of wheel ring 132. As shown, inner surface 184a may face radially inwardly of wheel ring 132 and outer surface 184b may face radially outwardly of wheel ring 132. In alternative embodiments, ring drivers 136 may engage outer surface 184b, and ring idlers 328 may engage inner surface 184a.

Returning to FIG. 21, each ring driver 136 includes a ring driver rotor 188 that engages wheel ring 132. Ring driver rotor 188 can take any form suitable for applying torque to wheel ring 132 for rotating the steering wheel attached to wheel ring 132. For example, ring driver rotor 188 may include a wheel 192 as shown, or a drive gear. Similarly, each ring idler 328 includes an idler rotor 332 that engages wheel ring 132. Idler rotors 332 can take any form suitable for applying and maintaining an opposing clamping force upon wheel ring 132 when in the engaged position, as ring driver 136 torques wheel ring 132 to rotate the connected steering wheel. For example, idler rotor 332 may include a wheel 336 as shown, or a drive gear.

Referring to FIGS. 22A-22B, ring driver rotors 188 are shown positioned radially inwardly of inner surface 184a and idler rotors 332 are shown positioned radially outwardly of outer surface 184b. In use, ring driver rotors 188 are movable radially relative to idler rotors 332 to transition between the disengaged position (FIG. 22A) and the engaged position (FIG. 22B). In the example shown, ring driver rotors 188 are movable radially outwardly relative to idler rotors 332, towards inner surface 184a, from the disengaged position (FIG. 22A) to the engaged position (FIG. 22B), and vice versa. This allows ring driver rotors 188 and idler rotors 332 to collectively clamp onto wheel ring 132 in the engaged position, and unclamp from wheel ring 132 in the disengaged position.

Ring driver rotors 188 and idler rotors 332 may have any alignment in the engaged position that allows for the rotors 188 and 332 to clamp onto wheel ring 132 securely. In some embodiments, each corresponding pair of rotors 188 and 332 (e.g. first rotor pair 188a and 332b, and second rotor pair 188b and 332b) may be substantially radially aligned. For example, the two radial lines connecting a center of wheel ring 132 to the rotor centers of a pair of rotors 188 and 332 may form an angle of less than 5 degrees. This may reduce the bending moment developed by the combination of normal forces applied by the rotors 188 and 332 within each pair.

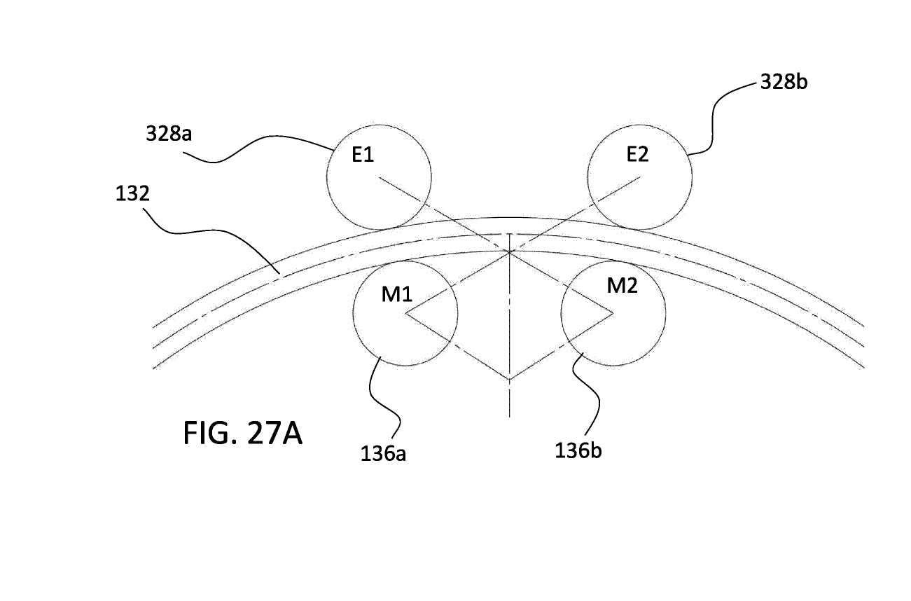

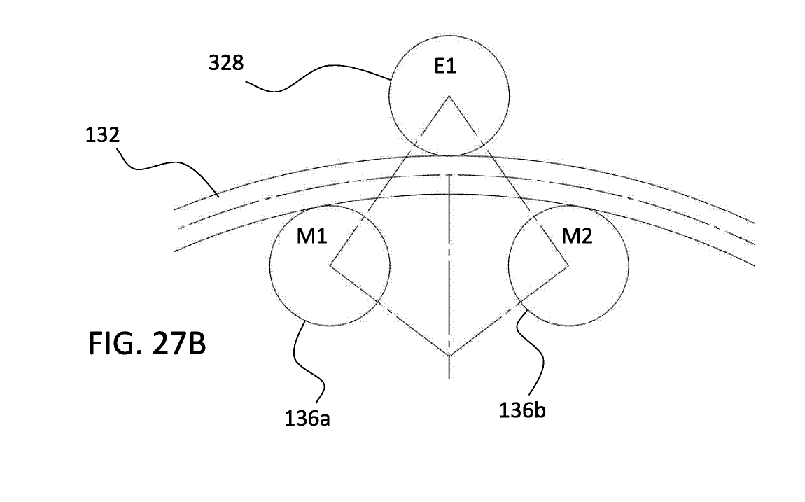

FIG. 27B shows a schematic arrangement of rotors 188 and 332 of a steering wheel controller in accordance with another embodiment. As shown, there may be just one idler rotor 332, which may be used to track the position of wheel ring 132, and one or more ring driver rotors 188, which may apply torque to drive the wheel ring 132 when in the engaged position.

Referring to FIG. 21, each ring driver 136 may include a motor 208 which drives the rotation of the ring driver rotor 188. This may provide greater total torque across ring drivers 136, all else being equal. In alternative embodiments, the plurality of ring drivers 136 may be driven by a common motor 208. This may reduce the size and cost of steering wheel controller 100, all else being equal.

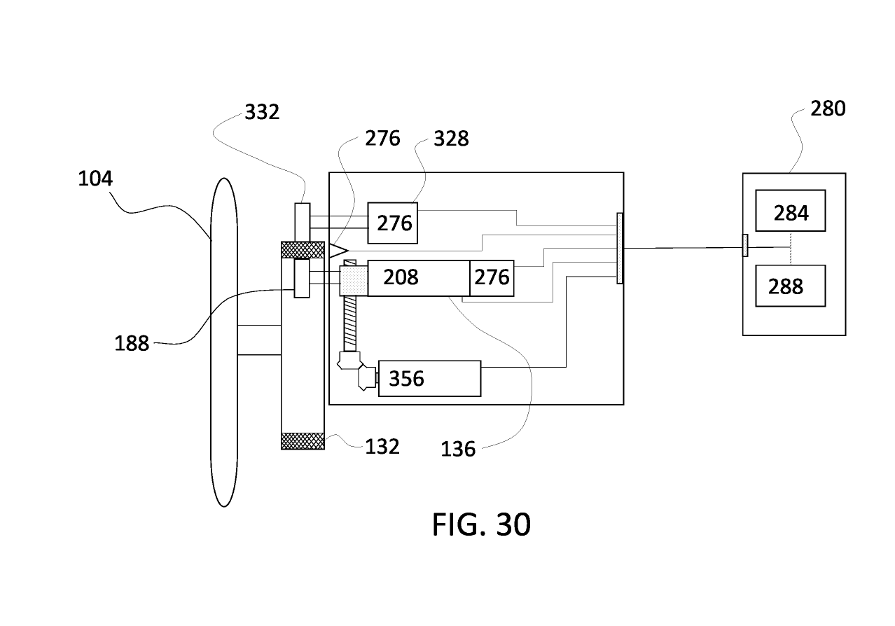

Steering wheel controller 100 may include any type(s) of rotary or position sensors suitable to determine the rotational position of wheel ring 132. For example, one or more (or all) of ring drivers 136 and ring idlers 328 may be equipped with a sensor (e.g. rotary encoder) that can sense angular rotation of the respective rotor(s) 188 and 332. The rotary sensors are communicatively coupled (e.g. by wire or wirelessly) to computing device 280 (FIG. 30), and send signals indicative of the sensed angular rotation to computing device 280 (FIG. 30). Computing device 280 (FIG. 30) interprets the signals received to determine the rotational position of wheel ring 132 and/or the connected steering wheel.

In the illustrated example, all of ring drivers 136 are equipped with a sensor 276, and sensors 276 are communicatively coupled to computing device 280 (FIG. 30). By having a plurality of ring drivers 136, each including its own motor 208 and sensor 276, computing device 280 (FIG. 30) may be better able to detect slippage (i.e. rotation of a ring driver rotor 188 that does not perfectly correspond to movement of wheel ring 132). For example, computing device 280 (FIG. 30) may compare angular rotation indicated by sensor signals from sensor 276a (obscured from view) to angular rotation indicated by sensor signals from sensor 276b, and determine there is slippage if the angular rotations (or the corresponding wheel ring rotation, e.g. in the case of differently sized wheels 192) do not match.

Still referring to FIG. 21, one or more (or all) of ring idlers 328 may be equipped with a sensor 276 that is communicatively coupled to computing device 280 (FIG. 30). Further, idler rotors 332 may retain rolling engagement with wheel ring 132 when steering wheel controller 100 is in the disengaged position (FIG. 22A). This may permit the sensor 276, which is positioned to sense the rotation of idler rotors 332, to continue to transmit sensor signals to computing device 280 (FIG. 30) when steering wheel controller 100 is in the disengaged position (FIG. 22A; e.g. when the user is manually controlling the steering wheel). As a result, computing device 280 (FIG. 30) may have accurate information about the position of wheel ring 132 and the connected steering wheel when steering wheel controller 100 is moved to the engaged position (FIG. 22B).

Ring driver rotors 188 and idler rotors 332 may be mounted in any manner that allows ring driver rotors 188 to move radially relative to idler rotors 332 between the disengaged position (FIG. 22A) and the engaged position (FIG. 22B). Turning to FIGS. 21 and 22A, rotors 188 and 332 are movably connected to one another by a rotary cross-mount 340. Rotary cross-mount 340 includes a first arm 344 that joins diagonally opposed rotors 188a and 332b, and a second arm 348 that joins diagonally opposed rotors 188b and 332a. Each of first and second arms 344 and 348 may be rotatable about a common axis 352. As shown, rotation axis 352 may extend parallel to the rotation axes of rotors 188 and 332. In the example shown, rotation axis 352 is located between rotors 188 and 332. As exemplified, rotation axis 352 may intersect wheel ring 132.

In the illustrated example, cross-mount first arm 344 rigidly connects rotors 188a and 332b, and cross-mount second arm 348 rigidly connects rotors 188b and 332a. As shown, cross-mount arms 344 and 348 may be pivotably connected to a center column 390, which defines cross-mount axis 352.

In use, rotary cross-mount 340 may articulate in a scissor-like manner. For example, first and second cross-mount arms 344 and 348 may articular in a scissor-like manner around rotation axis 352. First arm 344, carrying rotors 188a and 332b, may rotate in a first direction about axis 352 (e.g. clockwise or counterclockwise), and second arm 348, carrying rotors 188b and 332a, may rotate in the opposite direction about axis 352 (e.g. counterclockwise or clockwise), to move rotors 188 and 332 between the engaged and disengaged positions. For example, FIGS. 22A-22B show an example in which first arm 344 rotates clockwise and second arm 348 rotates counterclockwise to transition from the disengaged position to the engaged position. This causes rotors 188a and 332a to move toward each other and clamp (i.e. sandwich) onto wheel ring 132, and rotors 188b and 332b to move toward each other and clamp onto wheel ring 132, as shown. In the illustrated example, ring drivers 136 (including ring driver rotor 188 and motor 208) and ring idlers 328 (including idler rotor 332) are mounted to mounting arms 344 and 348, and move with rotors 188 and 332.

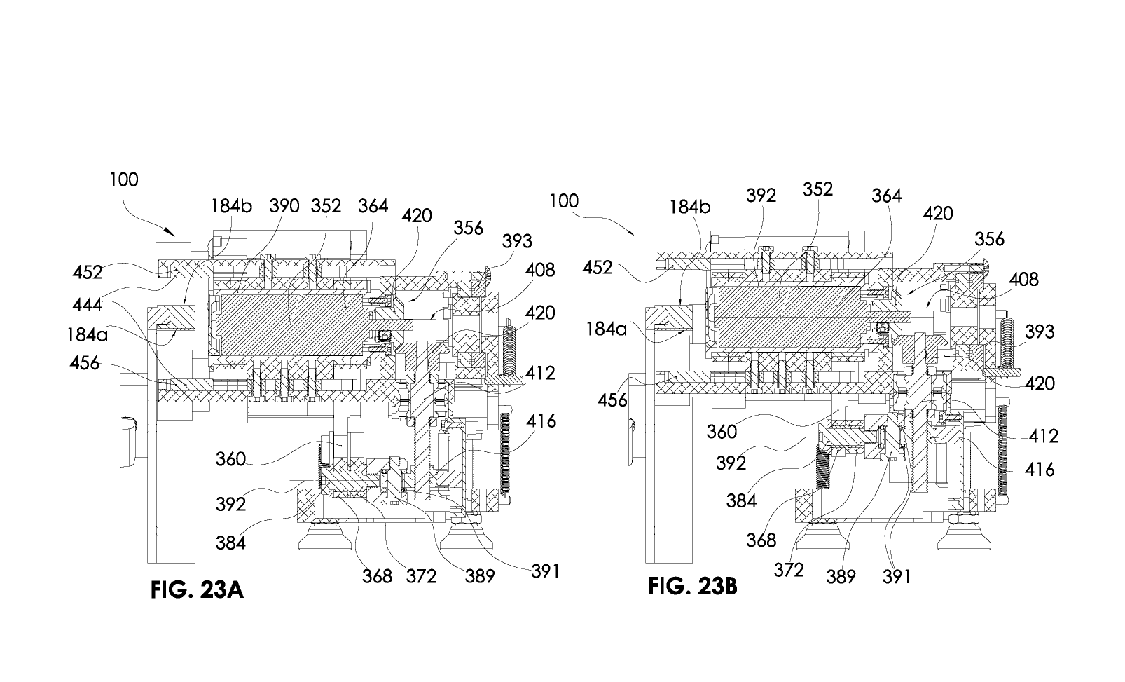

Turning to FIGS. 22A-22B and 23A-23B, steering wheel controller 100 may include an engagement actuator 356 that is operable to move steering wheel controller 100 between the engaged position (FIG. 22A) and the disengaged position (FIG. 22B). Actuator 356 may be any device suitable to move steering wheel controller 100 between the engaged and disengaged position. In the illustrated embodiment, actuator 356 includes a linkage 360 driven by a powered mover 364 (e.g. motor as shown, or solenoid). As shown, linkage 360 may be connected to first and second arms 344 and 348 of rotary cross-mount 340, and synchronize the movement of arms 344 and 348 between the disengaged position (FIGS. 22A and 23A) and engaged position (FIGS. 22B and 23B).

In some embodiments, linkage 360 may provide mechanical advantage between motor 364 and rotary cross-mount 340, at least when moving toward the engaged position to provide a greater clamping force. Linkage 360 can be any mechanical linkage suitable to provide such mechanical advantage. In the illustrated embodiment, linkage 360 is a toggle linkage. As shown, linkage 360 includes first and second arms 368 and 372. Each arm 368 and 372 has a first end 376 pivotally connected to a different one of cross-mount arms 344 and 348, and a second end 380 pivotally connected to a common drive pin 384. As shown, the first and second ends 376 and 380 may be pivotally connected to rotate about respective axes 388 and 392 substantially parallel to rotary cross-mount axis 352.

In use, motor 364 may be activated, such as by control signals from computing device 280 (FIG. 30), to drive linkage drive pin 384 to move radially relative to rotary cross-mount 340. For example, motor 364 may be activated to drive linkage drive pin 384 to move vertically (e.g. to rise or fall). In the illustrated example, motor 364 may drive linkage drive pin 384 to move in a radial direction aligned with (e.g. intersecting) rotary cross-mount axis 352. This may cause first and second linkage arms 368 and 372 to rotate about their respective first ends 376, whereby the second ends 380 of linkage arms 368 and 372 may move apart or toward each other. As the second ends 380 of linkage arms 368 and 372 move apart or toward each other, the connected rotary cross-mount arms 344 and 348 rotate about cross-mount axis 352 between the disengaged position (FIGS. 22A and 23A) and engaged position (FIGS. 22B and 23B).

FIGS. 22A-22B show an example where moving linkage drive pin 384 radially outwardly rotates first and second linkage arms 368 and 372 outwardly about axis 392 (e.g. towards a tangential orientation) whereby linkage arm second ends 380 move apart and the connected rotary cross-mount arms 344 and 348 rotate about rotary cross-mount axis 352 from the disengaged position (FIG. 22A) to the engaged position (FIG. 22B). In the illustrated example, from FIG. 22A to FIG. 22B, first linkage arm 368 is rotated counterclockwise, second linkage arm 372 is rotated clockwise, rotary cross-mount arm 344 is rotated clockwise, and rotary cross-mount arm 348 is rotated counter-clockwise.

Each of linkage arm 368 and 372 has a respective longitudinal axis 396 extending from the respective first end axis 388 to the second end common axis 392. As shown, longitudinal axes 396a and 396b of first and second arms 368 and 372 may form an inside angle 404 that increases as the linkage 360 moves from the disengaged position (FIG. 22A) to the engaged position (FIG. 22B). When actuating linkage 360, the movement speed of first and second linkage arms 368 and 372 decreases and the mechanical advantage increases towards infinity, as inside angle 404 approaches 180 degrees. This may permit linkage 360 to provide tremendous mechanical advantage in the engaged position (FIG. 22B) for robust clamping performance. In the other direction, the movement speed of first and second linkage arms 388 and 372 increases and the mechanical advantage decreases as inside angle 404 decreases below 180 degrees. This may permit linkage 360 to provide rapid disengagement of ring drivers 136 from wheel ring 132, such as to allow the human operator to quickly take over manual control of the steering wheel.

Referring to FIGS. 23A-23B, motor 364 may have any connection to linkage 360 that is suitable to permit motor 364 to drive linkage 360 between the disengaged position (FIG. 23A) and the engaged position (FIG. 23B). In the illustrated example, motor 364 is connected to linkage 360 by a transmission 408. Transmission 408 may be a rotary-to-linear movement converter, which converts the rotary output of motor 364 into a linear movement of linkage drive pin 384. As shown, transmission 408 may include a threaded shaft 412 that is threadably engaged with a nut 416. Nut 416 is connected to linkage drive pin 384. In use, motor 364 rotates threaded shaft 412 whereby nut 416 and the linkage drive pin 384 connected thereto are driven to translate along threaded shaft 412. As shown, threaded shaft 412 may be radially aligned for moving drive pin 384 in a radial direction.

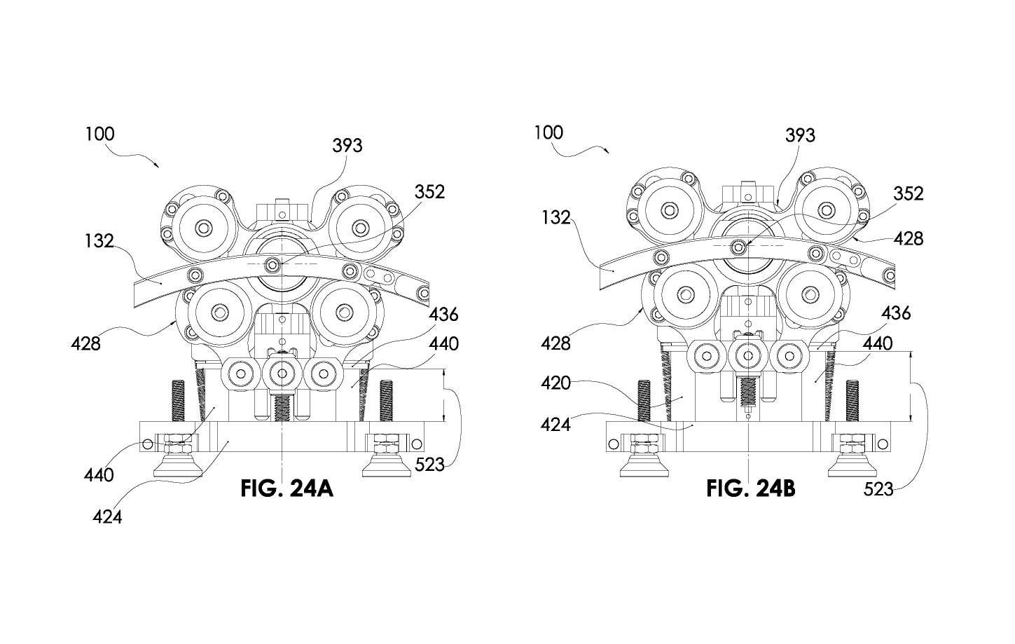

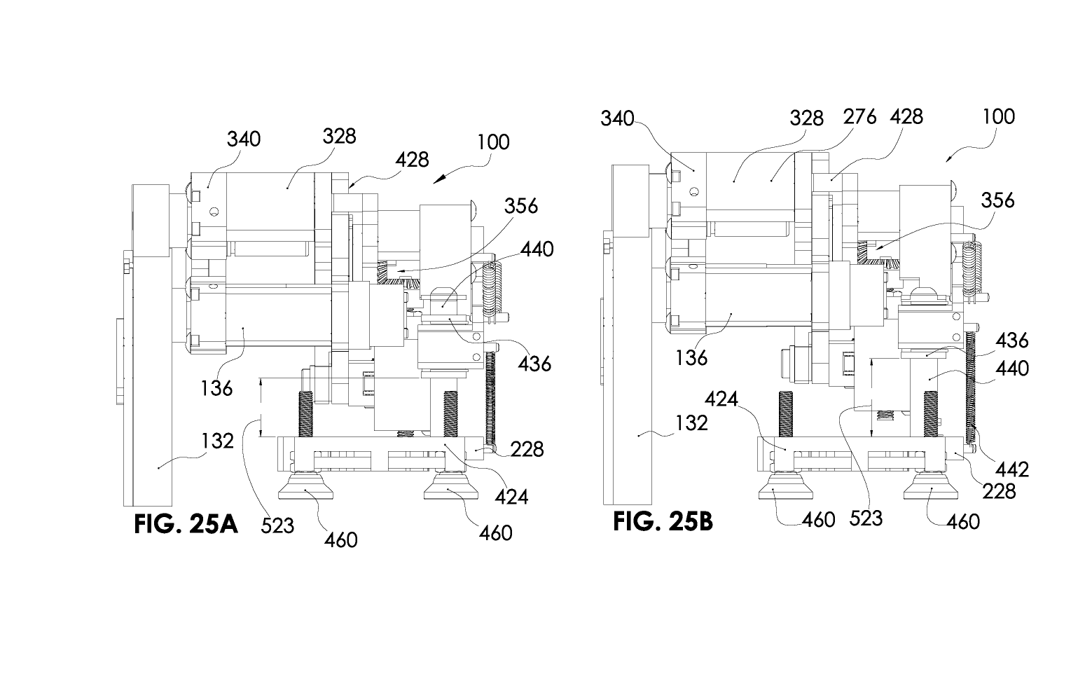

Motor 364 may be positioned to drive threaded shaft 412 directly or indirectly (e.g. by way of one or more belts or gears). In the illustrated example, motor 364 drives threaded shaft 412 indirectly by way of bevel gears 420. This allows motor 364 to be oriented perpendicular to threaded shaft 412. As show motor 364 may be positioned parallel with (e.g. collinear to) rotary cross-mount axis 352. This may provide a compact configuration, which may make steering wheel controller 100 more compatible with the space available in existing automobile models. Reference is now made to FIGS. 24A-24B and 25A-25B. In some embodiments, steering wheel controller 100 may include a stationary portion 424 and a mobile portion 428. Stationary portion 424 may include a dashboard mount 228, and mobile portion 428 may include the ring driver(s) 136, ring idler(s) 328 and associated mount(s) 340 and actuator(s) 356. Mobile portion 428 may also be referred to as the ‘drive assembly’ 428. Mounting assembly 424 may also be referred to as the ‘mounting assembly’ 424. As shown, dashboard mount 228 of mounting assembly 424 may include height adjustable leveling feet 460, which may be used to adjust the position and orientation of mounting assembly 424. Drive assembly 428 may be movably connected to mounting assembly 424. For example, drive assembly 428 may be rotatably connected to mounting assembly 424 (i.e. connected to mounting assembly 424 in a manner that permits drive assembly 428 to rotate relative to mounting assembly 424) or translationally connected to mounting assembly 424 (i.e. connected to mounting assembly 424 in a manner that permits drive assembly 428 to translate in a straight or curved path relative to mounting assembly 424). In one aspect, this may permit drive assembly 428 to move to accommodate radial runout of wheel ring 132 (e.g. imperfections in the circularity of wheel ring 132), and some misalignment between drive assembly 428 and wheel ring 132.

In the illustrated example, drive assembly 428 is radially movable relative to mounting assembly 424. For example, drive assembly 428 may be radially movable in a linear path relative to mounting assembly 424. FIGS. 24A and 25A show drive assembly 428 in a first radial position, and FIGS. 24B and 25B show drive assembly 428 moved radially outwardly to a second radial position. Drive assembly 428 may be connected to mounting assembly 424 in any manner suitable to allow drive assembly 428 to translate or rotate relative to mounting assembly 424 radially towards and away from wheel ring 132. In the illustrated example, drive assembly 428 is translationally connected to mounting assembly 424 by a sliding bearing assembly 432. Sliding bearing assembly 432 may include a linear bearing slideably mounted to a rail. One of mounting assembly 424 and drive assembly 428 may include the linear bearing, and the other of mounting assembly 424 and drive assembly 428 may include the rail. In the illustrated example, drive assembly 428 includes the linear bearing 436, and mounting assembly 424 includes the rail 440. However, this arrangement may be reversed.

Referring to FIG. 25B, drive assembly 428 may be biased relative to mounting assembly 424 to urge ring idlers 328 into contact with wheel ring 132. For example, drive assembly 428 may be pivotably or translationally biased relative to mounting assembly 424 (according to whether the connection between assemblies 424 and 428 is rotational or translational) whereby ring idlers 328 are urged radially inwardly towards wheel ring 132. This may provide constant contact between ring idlers 328 and wheel ring 132, so that sensors 276 of the ring idlers 328 can provide position and/or movement information related to wheel ring 132 whether steering wheel controller 100 is in the engaged position, the disengaged position, or while transitioning between positions.

In the illustrated example, drive assembly 428 is translationally biased radially inwardly relative to mounting assembly 424. Drive assembly 428 may be biased in any manner suitable to promote engagement between idler rotors 332 and wheel ring 132. In the example shown, sliding bearing assembly 432 includes a bias 442 (e.g. a spring) that connects linear bearing 436 to rail 440 and urges linear bearing 436 to slide radially inwardly along rail 440.

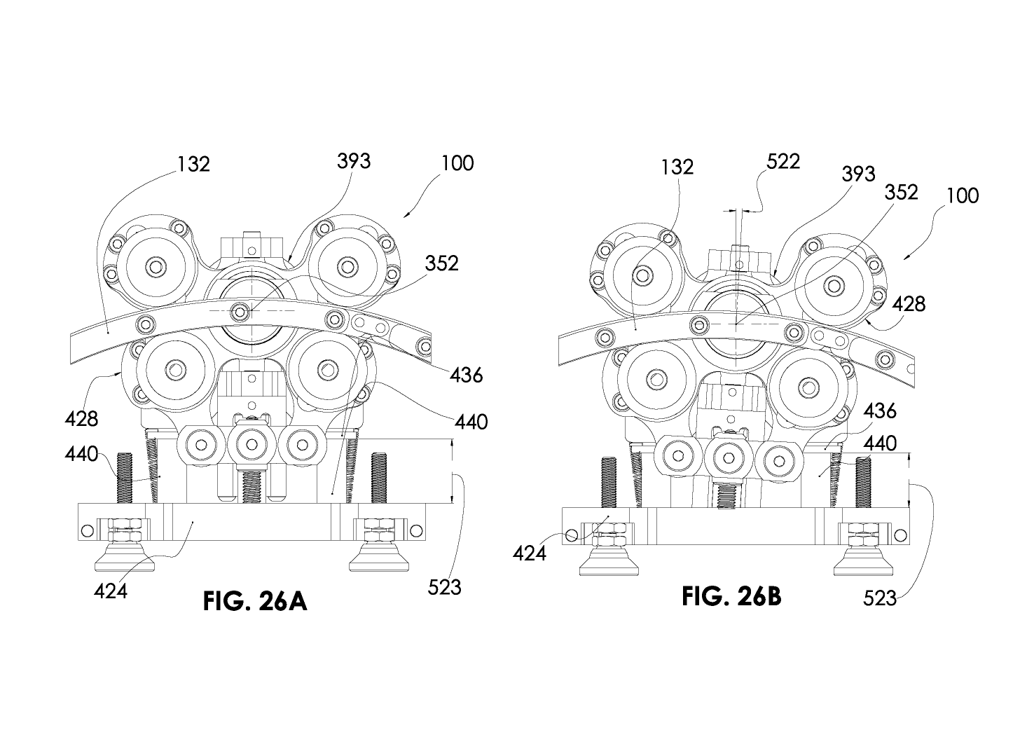

In some embodiments, wobble of wheel ring 132 with respect to steering wheel rotation axis 124 (FIG. 1) may result from radial run-out of the wheel ring radial surfaces 184a and 184b, and misalignment between a center plane of the drive assembly 428 from steering wheel rotation axis 124 (FIG. 1). FIGS. 26A-26B illustrate an embodiment that may provide drive assembly 428 with two degrees of freedom relative to mounting assembly 424 to tolerate these misalignments, which may arise from installation and vehicle build variations. This may permit drive assembly 428 to maintain engagement with wheel ring 132 when faced with wobble.

As shown, in a first degree of freedom, drive assembly 428 may be radially movable relative to mounting assembly 424. This may be achieved through linear rails 440 and linear bearings 436 as described above. In a second degree of freedom, at least rotors 188 and 332 of drive assembly 428 may be rotatable relative to mounting assembly 424 about axis 352. As shown, drive assembly 428 may be connected to linear bearing 436 by a bearing pack assembly 393. Consequently, rotary cross-mount 340 may be freely rotatable about axis 352 relative to wheel ring 132. FIGS. 26A and 26B show an example in which a wobble of wheel ring 132 is accommodated by angular and radial displacements 522 and 523 of drive assembly 428 relative to wheel ring 132. These two degrees of freedom may permit drive assembly 428 to tolerate all planar wobble of wheel ring 132.

Reference is now made to FIGS. 21 and 23A. In some embodiments, steering wheel controller 100 may include a homing sensor 444. Homing sensor 444 may be configured to detect an absolute reference feature 448 provided on wheel ring 132. Homing sensor 444 may be communicatively coupled to computing device 280 (FIG. 30, e.g. by wire or wirelessly). In use, homing sensor 444 may transmit a sensor signal to computing device 280 (FIG. 30) in response to detecting the absolute reference feature 448. In response to receiving the sensor signal from homing sensor 444, computing device 280 (FIG. 30) may reset the determined position of wheel ring 132 to a predetermined absolute reference position associated with absolute reference feature 448. This may permit computing device 280 (FIG. 30) to correct accumulating position error which may result from micro-slippage, wear (e.g. of wheel ring 132 and/or rotor 188 and/or rotors 332), or foreign objects on the wheel ring surfaces 184.

Homing sensor 444 may be a sensor of any kind suitable to detect an absolute reference feature 448 provided on wheel ring 132. For example, homing sensor 444 may be a magnetic sensor, an optical sensor, or a beam sensor (e.g. electromagnetic wave beam sensor). The absolute reference feature 448 may be any senseable feature having a fixed position on wheel ring 132. For example, absolute reference feature 448 may be a visibly distinct marking (e.g. bright white line), a magnet or magnetic member, or an aperture. In the illustrated embodiment, absolute reference feature 448 is an aperture and homing sensor 444 is a thru-beam optical sensor. As shown, aperture 448 is formed as a slit which pierces wheel ring 132 radially from inner surface 184a to outer surface 184b. Beam sensor 444 is shown including a beam emitter 452 (e.g. infrared light source), and a beam receptor 456, which are radially aligned so that aperture 448 is aligned between beam emitter 452 and beam receptor 456 when wheel ring 132 is in an absolute reference position known to computing device 280 (FIG. 30). In use, when wheel ring 132 is in the absolute reference position, beam receptor 456 shines a light beam through aperture 448 which is detected by beam receptor 456, and homing sensor 444 reports this to computing device 280. In every other position of wheel ring 132, light from beam receptor 456 is occluded by wheel ring 132 and not detected by beam receptor 456. It will be appreciated that the signal from homing sensor 444 indicative of alignment with aperture 448 may be a positive signal reporting this alignment, or a signal discontinuity (e.g. where sensor 444 sends a positive signal at all other times). In some embodiments, absolute reference feature 448 may be positioned in association with a neutral position of the connected steering wheel (e.g. when the vehicle is driving exactly straight forward). This may permit the absolute reference feature 448 to be frequently detected, and accumulating errors to be frequently mitigated.

As shown in FIG. 30, computing device 280 (e.g. having a processor 284 and memory 288) may be communicatively coupled (e.g. by wire or wirelessly) to ring driver(s) 136 and ring idler(s) 328. For example, computing device 280 may direct (e.g. send control signals to) ring driver(s) 136 to torque wheel ring 132, and receive sensor information from sensors 276 on the position and/or movement (e.g. rotation) of wheel ring 132, ring driver rotor(s) 188, and ring idler rotor(s) 332. Operating as a feedback loop, computing device 280 may send further control signals to ring driver 136 based on information from sensors 276.

In some embodiments, computing device 280 may determine whether there are inconsistencies between the sensed movement/position of wheel ring 132, ring driver rotor(s) 188, and ring idler rotor(s) 332. For example, an angular rotation of wheel ring 132 may correspond to a specific angular rotation of ring driver rotor(s) 188 and of ring idler rotor(s) 332, whereby slippage between wheel ring 132 and one or more of rotors 188 and 332 can be inferred where that relationship is not reflected in the sensor readings. Computing device 280 may determine whether the nature of the slippage indicates the user is attempting to retake control over the steering wheel 104. This may be referred to as a “manual override”. In response, computing device 280 may direct (e.g. send control signals to) engagement actuator 356 to move ring driver(s) 136 to the disengaged position whereby the user is allowed to have control over steering wheel 104. In other cases, computing device 280 may determine that the nature of the slippage indicates unintentional slippage (e.g. a consequence of terrain, such as potholes or uneven surfaces), free of any user intervention to retake control over the steering wheel 104. In response, computing device 280 may compensate for the slippage by sending additional directions (e.g. control signals) to ring driver(s) 136 (e.g. by applying additional torque).

Reference is now made to FIGS. 27A and 30, in which FIG. 27A shows a schematic illustration of wheel ring 132 engaged by ring driver rotors 188 and ring idler rotors 332. Computing device 280 may detect a manual override based at least in part on movements of ring idler rotors 332 and ring driver rotors 188 relative to each other and/or a command angle. The differences (delta “δ”) may be calculated as follows:

δ₁=k(M₁)−E₁ (1)

δ₂=k(M₂)−E₂ (2)

δ₃=k(M₁)−E₂ (3)

δ₄=k(M₂)−E₁ (4)

δ₅=α−E₁ (5)

where

E₁=k(M₁), and (6)

k=Rₒ/Rᵢ (7)

Differences (6) between the relative movements (e.g. travel distances) of idler rotors 332a, 332b and driver rotors 136a, 136b and command angle α may be used to detect an override condition. These may be indicative of slippages between wheel ring 132 and engaged rotors 332 and 188. In the formulas above, E₁, E₂, M₁, and M₂ represent the angular rotations of rotors 332a, 332b, 188a, and 188b respectively. Command angle (a) represents the target angular position of wheel ring 132 determined by computing device 280, and is expressed in terms of angular rotations of ring driver rotor 188a. Radius conversion factor (k) is the ratio of the outer radius (Rₒ) to the inner radius (Rᵢ) of the wheel ring outer and inner surfaces 184b and 184a respectively as noted in formula (7) above. Absent slippage, for a given angular rotation of wheel ring 132, ring driver rotor rotation E₁ is equal to the ring idler rotor rotation M₁ multiplied by the radius conversion factor k as noted in formula (6) above.

For clarity of illustration, the example shown and formulas above are based upon rotors 188 and 332 having the same wheel diameter. However, it will be appreciated that rotors 188 and 332 of different diameter may be used and the formulas revised accordingly.

Computing device 280 may determine a manual override condition having regard to any one or more (or all) of differences (1)-(6) above. Moreover, the described method of detecting a manual override may be applied to a steering wheel controller having two or more rotors 188 and 332. FIG. 27A illustrates an embodiment having 4 rotors 188 and 332. FIG. 27B illustrates an alternative embodiment having 3 rotors 188 and 332.

Still referring to FIGS. 27A and 30, while ring drivers 136 are in the engaged position, ring driver rotor motors 208 may be powered (e.g. in response to control signals from computing device 280) through a control loop to achieve a target position a for steering wheel 104. Computing device 280 may determine target position a from a digital source, such as for example a computer vision network in a self-driving vehicle or a remote driver operated joystick in a disability vehicle. Consideration of target position a by computing device 280 in detecting a manual override may permit the accommodation of slippage under normal driving conditions when the target position a is significantly different from the current steering wheel position (e.g. when the vehicle is about to enter a turn). For example, at the onset of motion, higher slippage is expected as ring driver 136 transmits torque to wheel ring 132 and overcomes the initial static momentum of wheel ring 132. Alpha “a” and its difference with respect to the current position of wheel ring 132 (δ5=α−E1), may drive the PID loop that computing device 280 may use to determine the power being supplied to drive rotor motors 208. Consequently, the potential for slipping increases under non-override conditions, and therefore should not be determined by computing device 280 as an attempt by the user to take manual control over steering wheel 104.

In some embodiments, computing device 280 may determine a manual override event having regard to characteristic manual override signatures, which may include time-patterns of the above described difference values. A long-short term memory (LSTM) neural network may be used to identify and isolate manual override signatures. Other methods may include segmentation, and analytical methods that utilize thresholds on multi-variable factors that combine one or more (or all) of the input variables described above (E1, E2, M1, M2, α).

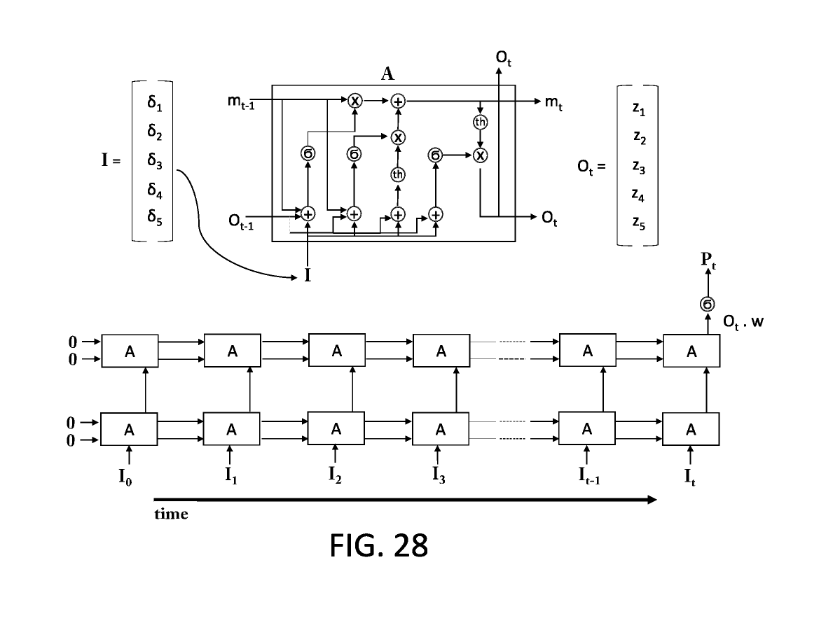

FIG. 28 illustrates an exemplary manual override signature identification method using an LSTM. As shown, a back-propagating gradient descent algorithm may be used to tune the weights of the LSTM network using test data that has been pre-labeled with manual override events against the signature variables described above (δ₁, δ₂, δ₃, . . . ). Labeled data (used for training) is labeled with “1” for override conditions and “0” for engaged operation of the wheel controller with the user keeping their hands off the steering wheel. In the illustrated example, input vector I may use a time component for the network to “remember” the previous states of the signature variables so as to determine its change over time. The past values of vector I are represented as Iₜ, Iₜ₋₁, Iₜ₋₂, . . . Iₜ₋ₙ. Where n is the oldest state vector I in the LSTM network. For example, in one embodiment, n=50, where each slice of time/data, t=30 ms, and as such the LSTM network, “remembers” the data from 1.5 seconds prior. The output from the LSTM cell may be in the same form as the input (e.g. a vector of 5 variables) and may continue to feed the next cell of the network in the overall arrangement. All operations described in FIG. 28, (+add, x multiply . . . ) are non-vector versions of these operation applied to each element of vector I, element-wise. In FIG. 28. The final output of the network may combine the 5 elements of Oₜ to a final probability output Pₜ, which predicts a manual override condition (e.g. when it has a value close to 1) or predicts normal driving conditions (e.g. when it has a value close to 0).

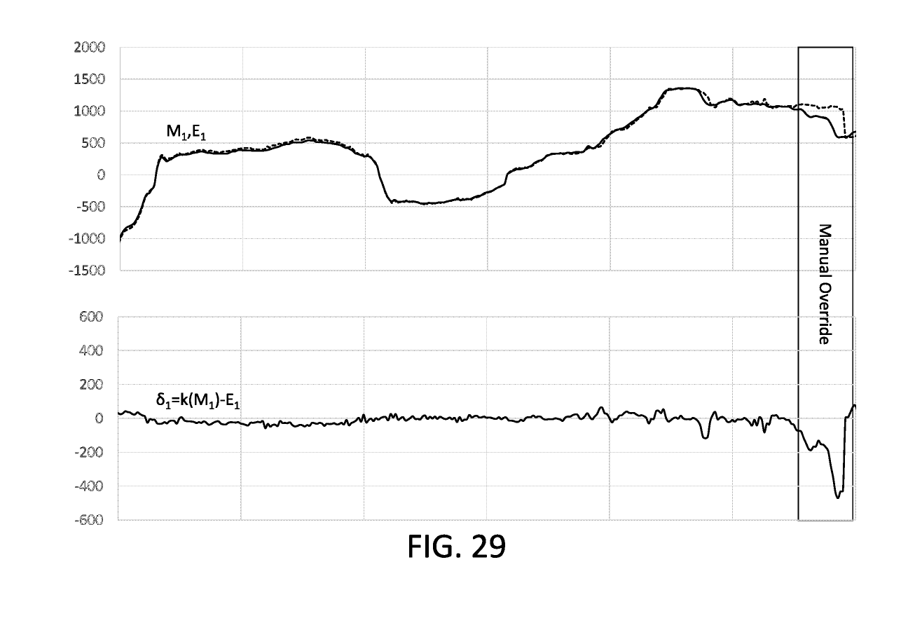

FIG. 29 is a graphical example of data plotting the positions of a ring driver rotor M1 and a ring idler rotor E1, including normal operation and manual override conditions. As shown, a difference between the positions M1 and E1 may be indicative of a manual override condition.

While the above description provides examples of the embodiments for the invention, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A steering wheel controller mountable to a steering wheel of a vehicle, the steering wheel having a steering wheel axis and a steering wheel rim, the steering wheel rim having hand gripping surfaces that face away from the steering wheel axis, the steering wheel controller comprising:
a steering wheel mount securable to the steering wheel without obstructing the hand gripping surfaces;
a wheel ring connected to the steering wheel mount, the wheel ring defining a wheel ring axis of rotation,
   wherein when the steering wheel mount is secured to the steering wheel, the wheel ring is located rearward of the steering wheel; and
at least one ring driver engageable with the wheel ring, and when engaged with the wheel ring controllable to selectively torque the wheel ring to rotate with the steering wheel mount about the wheel ring axis of rotation.
   Item 2: The steering wheel controller of item 1, wherein:
the wheel ring comprises an engagement surface that forms a closed loop around the wheel ring axis of rotation, and
each of the one or more ring drivers comprises a rotor engageable with the engagement surface and when engaged selectively rotatable to torque the wheel ring to rotate.
   Item 3: The steering wheel controller of item 2, wherein:
the engagement surface comprises a toothed surface,
each rotor comprises a drive gear, and
each drive gear is meshed with the toothed surface when engaged with the engagement surface.
   Item 4: The steering wheel controller of item 2, wherein:
each rotor comprises a wheel, and
each wheel makes frictional rolling engagement with the engagement surface when engaged with the engagement surface.
   Item 5: The steering wheel controller of any one of items 2-4, wherein:
the engagement surface faces outwardly away from the wheel ring axis of rotation.
   Item 6: The steering wheel controller of any one of items 2-4, wherein:
the engagement surface faces inwardly towards the wheel ring axis of rotation.
   Item 7: The steering wheel controller of item 1, wherein:
the wheel ring comprises a plurality of rotor permanent magnets distributed around the wheel ring axis of rotation; and
each ring driver comprises at least two stator electromagnets that are selectively energizable to magnetically torque the wheel ring to rotate about the wheel ring axis of rotation.
   Item 8: The steering wheel controller of item 7, wherein:
the rotor magnets are evenly distributed around the wheel ring axis of rotation according to a rotor magnet pitch; and
the two stator electromagnets are spaced apart according to a stator electromagnet pitch that is not a whole number multiple of the rotor magnet pitch.
   Item 9: The steering wheel controller of any one of items 1-8, wherein:
the steering wheel mount comprises at least one steering wheel rim coupler collectively securable to a steering wheel rim.
   Item 10: The steering wheel controller of item 9, wherein:
the at least one steering wheel rim coupler comprises a plurality of steering wheel rim couplers, each steering wheel rim coupler having a steering wheel engagement surface facing away from the wheel ring axis of rotation.
   Item 11: The steering wheel controller of any one of items 9-10, wherein:
each steering wheel rim coupler is movable outwardly away from the wheel ring axis of rotation towards an engaged position.
   Item 12: The steering wheel controller of any one of items 1-8, wherein:
the steering wheel mount comprises at least one steering wheel hub coupler securable to a hub of a steering wheel.
   Item 13: The steering wheel controller of any one of items 2-6, further comprising:
a wheel ring sensor that senses one or both of (i) movement of the wheel ring, and (ii) position of the wheel ring; and
at least one ring driver sensor, each ring driver sensor sensing one or both of (i) movement of the rotor of one of the at least one rotor, and (ii) position of the rotor of one of the at least one rotor.
   Item 14: The steering wheel controller of any one of items 1-14, wherein:
each ring driver is resiliently biased into physical engagement with the wheel ring.
   Item 15: The steering wheel controller of item 14, wherein:
each ring driver is resiliently biased in a radial direction into physical engagement with the wheel ring.
   Item 16: The steering wheel controller of any one of items 1-15, further comprising:
at least one ring idler; and
a mount connecting the at least one ring idler to the at least one ring driver, the mount being movable between an engaged position in which the mount holds the at least one ring idler and the at least one ring driver collectively in engagement with opposed faces of the wheel ring, and a disengaged position in which the mount holds the at least one ring driver in disengagement with the wheel ring.
   Item 17: The steering wheel controller of item 16, wherein:
in the disengaged position, the mount holds the at least one ring idler in engagement with the wheel ring.
   Item 18: The steering wheel controller of any one of items 1-14, further comprising:
a clutch assembly controllable to selectively stop the transmission of torque from the at least one ring driver to the wheel ring.
   Item 19: The steering wheel controller of any one of items 16-17, further comprising:
a toggle linkage connected to the mount, the toggle linkage being movable across a position of peak mechanical advantage to drive the mount between the engaged position and the disengaged position.
   Item 20: The steering wheel controller of any one of items 1-19, further comprising:
a dashboard mount connected to the ring driver and securable to a stationary surface of a vehicle.
   Item 21: The steering wheel controller of any one of items 1-19, further comprising:
a steering column mount connected to the ring driver and securable to a fixed surface of a vehicle.
   Item 22: The steering wheel controller of item 20, wherein:
the dashboard mount comprises height adjustable leveling feet.
   Item 23: The steering wheel controller of any one of items 1-19, further comprising:
a drive assembly including the at least one ring driver, and a mounting assembly, wherein the drive assembly is movably connected to the mounting assembly with at least one degree of freedom.
   Item 24: The steering wheel controller of any one of items 1-15, further comprising:
at least one ring idler; and
a mount carrying the at least one ring idler and the at least one ring driver, the mount being rotatable relative to the wheel ring.
   Item 25: The steering wheel controller of any one of items 1-15, further comprising:
at least one ring idler; and
a mount carrying the at least one ring idler and the at least one ring driver, the mount being translatable relative to the wheel ring.
   Item 26: The steering wheel controller of any one of items 24-25, wherein:
the mount is biased to urge the at least one ring driver and the at least one ring idler into engagement with the wheel ring.
   Item 27: The steering wheel controller of item 1, further comprising:
at least one ring idler engageable with the wheel ring;
one or more sensors collectively operable to sense one or both of movement and position, of each ring idler, each ring driver, and the wheel ring; and
a computing device communicatively coupled to each of the sensors, and configured to determine a manual override based at least in part on a discrepancy between sensor information of the ring idler(s), ring driver(s), and the wheel ring.
   Item 28: The steering wheel controller of item 27, further comprising:
a mount carrying the at least one ring idler and the at least one ring driver; and
an actuator operable to move the mount between an engaged position and a disengaged position,
wherein the computing device is configured to direct the actuator to move the mount to the disengaged position in response to determining the manual override.
   Item 29: A method of electronically controlling a steering wheel of a vehicle, the method comprising:
at least one ring driver collectively applying torque to a wheel ring connected to a steering wheel, the wheel ring positioned rearward of the steering wheel, the torque rotating the steering wheel about an axis of a steering column connected to the steering wheel, the steering wheel having unobstructed hand gripping surfaces that face away from the axis.
   Item 30: The method of item 29, wherein:
said applying torque comprises rotating a rotor of each ring driver, each rotor being engaged with the wheel ring.
   Item 31: The method of item 29, wherein:
said applying torque comprises the ring driver energizing stator electromagnets that magnetically move rotor magnets of the wheel ring.
   Item 32: The method of any one of items 29-31, further comprising:
sensing one or both of (i) movement of the wheel ring, and (ii) position of the wheel ring; and
sensing one or both of (i) movement of the rotor, and (ii) position of the rotor.
   Item 33: The method of item 32, wherein:
said sensing comprises receiving signals from one or more of an optical sensor, an electromagnetic sensor, a magnetic sensor, or an ultrasonic sensor.
   Item 34: The method of item 31, wherein:
energizing the stator electromagnets comprises creating a magnetic field, the magnetic field being oriented in a radial direction of the steering wheel or in an axial direction of the steering wheel.
   Item 35: The method of item 31, wherein
energizing the stator electromagnets comprises, sequentially energizing three or more electromagnetic windings.
   Item 36: A method of determining a manual override in a vehicle equipped with a steering wheel controller, the steering wheel controller having at least two rotors engaged with a wheel ring, the wheel ring connectable to a steering wheel, and at least one of the two rotors being controllable to torque the wheel ring to rotate, the method comprising:
sensing rotary movement of each of the rotors,
determining slippage between the rotors and the wheel ring based at least in part on a discrepancy between the sensed rotary movements of the rotors, and
determining a manual override condition based at least in part on the determined slippage.
   Item 37: The method of item 37, further comprising:
training a neural network identify slippage characteristics associated with a manual override,
wherein said determining the manual override condition comprises comparing the determined slippage against the identified slippage characteristics.

1. A steering wheel controller mountable to a steering wheel of a vehicle, the steering wheel having a steering wheel axis and a steering wheel rim, the steering wheel rim having hand gripping surfaces that face away from the steering wheel axis, the steering wheel controller comprising:
a steering wheel mount securable to the steering wheel without obstructing the hand gripping surfaces;
a wheel ring connected to the steering wheel mount, the wheel ring defining a wheel ring axis of rotation,
wherein when the steering wheel mount is secured to the steering wheel, the wheel ring is located rearward of the steering wheel; and
at least one ring driver engageable with the wheel ring, and when engaged with the wheel ring controllable to selectively torque the wheel ring to rotate with the steering wheel mount about the wheel ring axis of rotation.

2. The steering wheel controller of claim 1, wherein:
the wheel ring comprises one or more engagement surfaces, each engagement surface forming a closed loop around the wheel ring axis of rotation, and
each of the one or more ring drivers comprises a rotor engageable with at least one of the engagement surfaces and when engaged selectively rotatable to torque the wheel ring to rotate.

3. The steering wheel controller of claim 2, wherein:
each rotor comprises a wheel, and
each wheel makes frictional rolling engagement with the at least one of the engagement surfaces when engaged with the at least one of the engagement surfaces.

4. The steering wheel controller of claim 2-3, wherein:
each engagement surface faces radially of the wheel ring axis of rotation.

5. The steering wheel controller of claim 1, wherein:
the steering wheel mount comprises at least one steering wheel rim coupler collectively securable to a steering wheel rim.

6. The steering wheel controller of claim 5, wherein:
the at least one steering wheel rim coupler comprises a plurality of steering wheel rim couplers, each steering wheel rim coupler having a steering wheel engagement surface facing away from the wheel ring axis of rotation.

7. The steering wheel controller of claim 5, wherein:
each steering wheel rim coupler is movable outwardly away from the wheel ring axis of rotation towards an engaged position.

8. The steering wheel controller of claim 2, further comprising:
a wheel ring sensor that senses one or both of (i) movement of the wheel ring, and (ii) position of the wheel ring; and
at least one ring driver sensor, each ring driver sensor sensing one or both of (i) movement of the rotor of one of the at least one rotor, and (ii) position of the rotor of one of the at least one rotor.

9. The steering wheel controller of claim 1, wherein:
each ring driver is resiliently biased into physical engagement with the wheel ring.

10. The steering wheel controller of claim 9, wherein:
each ring driver is resiliently biased in a radial direction into physical engagement with the wheel ring.

11. The steering wheel controller of claim 1, further comprising:
at least one ring idler; and
a mount connecting the at least one ring idler to the at least one ring driver, the mount being movable between an engaged position in which the mount holds the at least one ring idler and the at least one ring driver collectively in engagement with opposed faces of the wheel ring, and a disengaged position in which the mount holds the at least one ring driver in disengagement with the wheel ring.

12. The steering wheel controller of claim 11, wherein:
in the disengaged position, the mount holds the at least one ring idler in engagement with the wheel ring.

13. The steering wheel controller of claim 1, further comprising:
a clutch assembly controllable to selectively stop the transmission of torque from the at least one ring driver to the wheel ring.

14. The steering wheel controller of claim 11, further comprising:
a toggle linkage connected to the mount, the toggle linkage being movable across a position of peak mechanical advantage to drive the mount between the engaged position and the disengaged position.

15. The steering wheel controller of claim 1, further comprising:
a drive assembly including the at least one ring driver, and a mounting assembly, wherein the drive assembly is movably connected to the mounting assembly with at least one degree of freedom.

16. The steering wheel controller of claim 1, further comprising:
at least one ring idler; and
a mount carrying the at least one ring idler and the at least one ring driver, the mount being rotatable relative to the wheel ring.

17. The steering wheel controller of claim 1, further comprising:
at least one ring idler; and
a mount carrying the at least one ring idler and the at least one ring driver, the mount being translatable relative to the wheel ring.

18. The steering wheel controller of claim 16, wherein:
the mount is biased to urge the at least one ring driver and the at least one ring idler into engagement with the wheel ring.

19. The steering wheel controller of claim 1, further comprising:
at least one ring idler engageable with the wheel ring;
one or more sensors collectively operable to sense one or both of movement and position, of each ring idler, each ring driver, and the wheel ring; and
a computing device communicatively coupled to each of the sensors, and configured to determine a manual override based at least in part on a discrepancy between sensor information of the ring idler(s), ring driver(s), and the wheel ring.

20. The steering wheel controller of claim 19, further comprising:
a mount carrying the at least one ring idler and the at least one ring driver, and
an actuator operable to move the mount between an engaged position and a disengaged position,
wherein the computing device is configured to direct the actuator to move the mount to the disengaged position in response to determining the manual override.
